(19) United States
(12) Patent Application Publication
(10) Pub. No.: US 2013/0276986 A1
(43) Pub. Date: Oct. 24, 2013

(54) Fold-Under Pressure Sensitive Shipping Labels And Print And Apply Machines For Labeling Packages Using Same

(71) Applicant: Ward Kraft, Inc., Fort Scott, KS (US)

(72) Inventors: Johnny Bellmyer, Fort Scott, KS (US); Randy Sloan, Mannford, OK (US)

(73) Assignee: Ward Kraft, Inc.

(21) Appl. No.: 13/927,604

(22) Filed: Jun. 26, 2013

Related U.S. Application Data
(63) Continuation of application No. 13/841,248, filed on Mar. 15, 2013.
(60) Provisional application No. 61/614,972, filed on Mar. 23, 2012.
(60) Provisional application No. 61/664,473, filed on Jun. 26, 2012.
(60) Provisional application No. 61/673,540, filed on Jul. 19, 2012.
(60) Provisional application No. 61/701,209, filed on Sep. 14, 2012.

(51) Int. Cl. B65C 9/46; B65C 9/00

(52) U.S. Cl. CPC B65C 9/46; B65C 9/00
USPC 156/378; 156/387; 156/443

(57) ABSTRACT

An apparatus for folding and applying a fold-under label to a substrate comprises a folding station having a stop and a folding arm. The apparatus further comprises an application station having an affixing member. The folding arm is configured to fold the fold-under label by transitioning from a first position adjacent the stop to a second position adjacent the affixing member. The affixing member is configured to apply the folded fold-under label to the substrate by transitioning from an initial position to a final position.

### CROSS-REFERENCE TO RELATED APPLICATIONS

This application is a continuation of U.S. patent application Ser. No. 13/841,248 filed Mar. 15, 2013 which claims priority to U.S. Provisional Patent Application No. 61/614,972 filed Mar. 23, 2012; U.S. Provisional Patent Application No. 61/664,473 filed Jun. 26, 2012; U.S. Provisional Patent Application No. 61/673,540 filed Jul. 19, 2012; and U.S. Provisional Patent Application No. 61/701,209 filed Sep. 14, 2012. The disclosure of each is incorporated herein in its entirety by reference.

### BACKGROUND

The invention relates generally to the field of print and apply machines. More specifically, the invention relates to the field of print and apply machines used with fold-under labels.

### SUMMARY

Apparatuses for printing, folding and applying fold-under labels to substrates are disclosed herein. According to one embodiment, an apparatus for printing, folding, and applying a fold-under label to a substrate comprises a printing station including a printer and a folding station having a stop, a rotatable member, and a folding arm operably coupled to the rotatable member. The apparatus further comprises an application station having an affixing member operably coupled to an extendable rod. The folding arm is configured to fold the fold-under label by transitioning from a first position adjacent the stop to a second position adjacent the affixing member upon rotation of the rotatable member. The affixing member is configured to apply the folded fold-under label to the substrate by transitioning from an initial position to a final position.

According to another embodiment, an apparatus for folding and applying a fold-under label to a substrate comprises a folding station having a stop and a folding arm. The apparatus further comprises an application station having an affixing member. The folding arm is configured to fold the fold-under label by transitioning from a first position adjacent the stop to a second position adjacent the affixing member. The affixing member is configured to apply the folded fold-under label to the substrate by transitioning from an initial position to a final position.

According to another embodiment, an apparatus for printing, folding, and applying a fold-under label to a substrate comprises a printing station including a printer, and a folding station having a stop and a folding arm. The apparatus further comprises an application station having an affixing member. The affixing member has a sensor configured to read a timing mark on the fold-under label. The folding arm is configured to fold the fold-under label by transitioning from a first position adjacent the stop to a second position adjacent the affixing member. The affixing member is configured to apply the folded fold-under label to the substrate by transitioning from an initial position to a final position.

According to yet another embodiment, an apparatus for printing and folding a fold-under label comprises a printing station including a printer and a folding station having a stop and a folding arm operably coupled to a rotatable member. The folding arm is configured to fold the fold-under label by transitioning from a first position to a second position upon rotation of the rotatable member.

### BRIEF DESCRIPTION OF THE SEVERAL VIEWS OF THE DRAWINGS

Illustrative embodiments of the present invention are described in detail below with reference to the attached drawing figures.

FIG. 1 is a front view of a fold-under label, according to one embodiment of the present invention.

FIG. 2 is a rear view of the fold-under label of FIG. 1.

FIG. 3 shows sensitive and non-sensitive information placed on an inner and outer label of the fold-under label of FIG. 1, respectively.

FIG. 4 is a rear view of the fold-under label of FIG. 3 after the inner label has been folded underneath the outer label.

FIG. 5 is a front view of the fold-under label of FIG. 3 after the inner label has been folded underneath the outer label.

FIG. 6 is a front view of the fold-under label of FIG. 3 after it is adhered to a package.

FIG. 7 is a front view of the fold-under label and package of FIG. 6 after the tearing of a tear strip of the fold-under label.

FIGS. 8 and 9 show the inner and outer labels being detached from a remainder of the fold-under label of FIG. 3.

FIG. 10(a) is a front view of an alternate embodiment of the fold-under label of FIG. 1.

FIG. 10(b) is a rear view of another alternate embodiment of the fold-under label of FIG. 1.

FIG. 11 is a rear view of another alternate embodiment of the fold-under label of FIG. 1 with a liner shown separate from the label.

FIGS. 12 and 13 show the inner label being detached from a remainder of the fold-under label of FIG. 11.

FIG. 14(a) is a front view of another alternate embodiment of the fold-under label of FIG. 1.

FIGS. 14(b) and 14(c) are rear views of the fold-under label of FIG. 14(a) showing exemplary placement of an adhesive and a release material.

FIG. 15(a) is a front view of another alternate embodiment of the fold-under label of FIG. 1.

FIG. 15(b) is a rear view of the fold-under label of FIG. 15(a).

FIG. 15(c) is a rear view of the fold-under label of FIG. 15(a) after a fourth portion and a fifth portion have been folded behind a top portion.

FIG. 15(d) is a rear view of the fold-under label of FIG. 15(a) after the top portion and the middle portion have been folded behind a bottom portion.

FIG. 15(e) is a rear view of an alternate embodiment of the fold-under label of FIG. 15(a).

FIG. 16(a) is a front view of another alternate embodiment of the fold-under label of FIG. 1.

FIG. 16(b) is a rear view of the fold-under label of FIG. 16(a).

FIG. 17(a) is a rear view of yet another alternate embodiment of the fold-under label of FIG. 1.

FIG. 17(b) is a perspective representation of a card placing apparatus used to releasably secure a card onto the label of FIG. 17(a).

FIG. 18 is a perspective representation of a print and apply machine, according to one embodiment of the present invention.

FIGS. 19 and 20 are perspective representations of the print and apply machine of FIG. 18 showing a folding arm of the print and apply machine moving from an initial position to a final position to fold a respective fold-under label.

FIGS. 21 and 22 are perspective representations of the print and apply machine of FIG. 18 showing the folding arm moving from the final position back to its initial position after the folding of a respective fold-under label.

FIG. 23 shows an affixing member of the print and apply machine of FIG. 18 moving from an initial position to a final position to apply the folded label of FIG. 1 to an envelope.

FIG. 24 shows the affixing member after it has moved back from the final position to its initial position after application of the fold-under label of FIG. 1 to the envelope.

FIG. 25 is a flow diagram outlining a method for printing, folding, and applying the fold-under label of FIG. 1 to an envelope.

### DETAILED DESCRIPTION

Embodiments of the present invention provide fold-under pressure sensitive shipping labels and methods for making and applying same. In this document, references are made to directions such as front, back, left, right, top, bottom, and the like. These references are exemplary only and are used to describe the disclosed invention in a typical orientation or operation, but are not independently limiting.

Shipping labels are well known in the art. These labels are often adhered to packages being shipped from one location to another. Typically, shipping labels include a surface configured for printing of indicia, such as the recipient's name and address, the contents of the package, delivery instructions, et cetera. The printable surface generally includes adhesive (e.g., pressure sensitive adhesive) at its reverse side so that the shipping label may be removably secured to a backing sheet, such as a silicone coated release liner. When the shipping label is to be secured to a package, indicia is placed on the label and the backing sheet is removed. The label is then adhered to the package using the adhesive.

A recipient of the package to which such a shipping label is adhered may wish for certain information placed on the shipping label to be concealed. For instance, the shipping label may list the contents of the package, which may include, for example, medications or a present which the recipient has purchased for someone else, and the recipient may wish for this information to not be publicly displayed on the shipping label. Fold-under (or tuck-under) shipping labels provide a solution to this problem. Fold-under shipping labels generally include an outer printable label and an inner printable label that can be folded or tucked underneath the outer label before the fold-under label is secured to the package. Sensitive information (e.g., package contents) may be provided on the inner label and is therefore desirably concealed from view by the outer label. Non-sensitive information (e.g., the recipient's shipping address), conversely, may be placed on the outer label. Generally, the inner label is folded underneath the outer label by hand, and the fold-under label is manually secured to the respective package. When the recipient receives the package, he may remove the outer label to access the inner label.

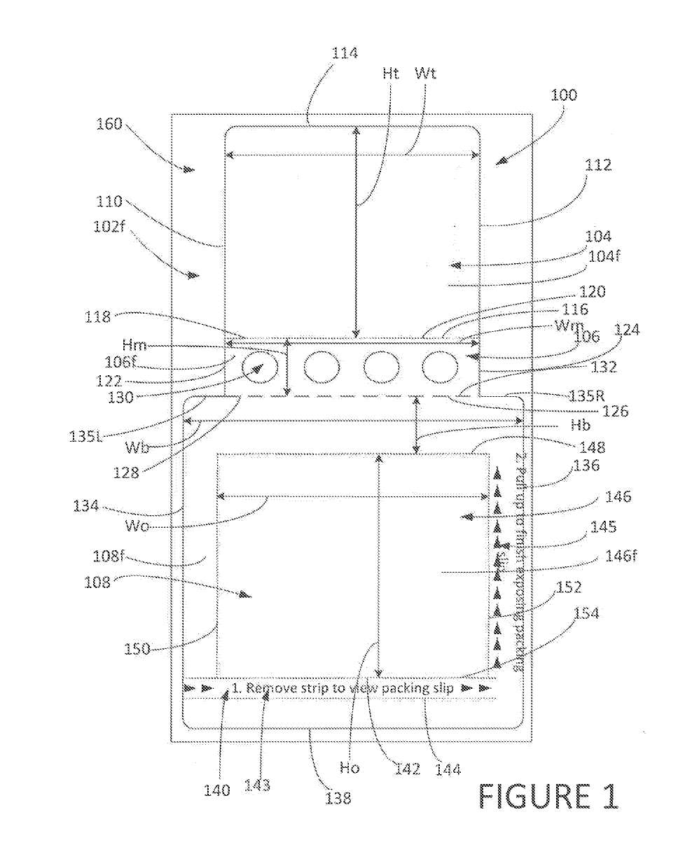

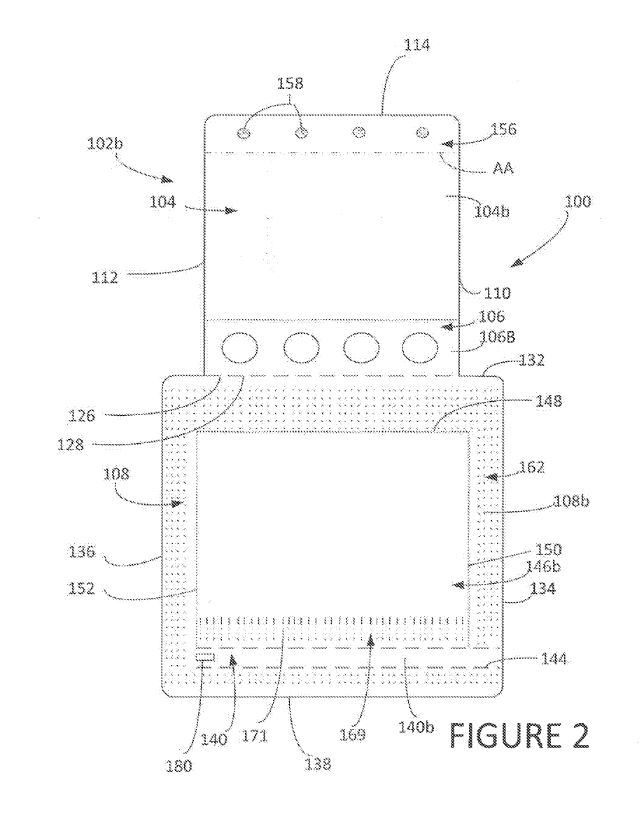

FIGS. 1 and 2 show an embodiment 100 of a fold-under label in line with the teachings of the present invention. A front side 102f of the fold-under label 100 is shown in FIG. 1. As can be seen, the fold-under label 100 has a top portion 104 (or a “first portion”) having a front face 104F, a middle portion 106 (or a “second portion”) having front face 106F, and a bottom portion 108 (or a “third portion”) having a front face 108F, respectively. FIG. 2 shows a back side 102b of the label 100 (after a backing sheet has been removed, as described in more detail below); specifically, FIG. 2 shows a back face 104b of the top portion 104, a back face 106b of the middle portion 106, and a back face 108b of the bottom portion 108.

Attention is now directed to FIG. 1. The top portion 104 may have a left edge 110 and a right edge 112 which may be generally parallel to each other and extend generally vertically. The top portion 104 may have a top edge 114 which may extend generally horizontally, and the left and right edges 110, 112 of the top portion 104 may smoothly merge with the top edge 114. A bottom side 116 of the top portion 104 may oppose and be generally parallel to its top edge 114. A width Wt (i.e., the lateral distance between the left edge 110 and the right edge 112) and a height Ht (i.e., the vertical distance between the top edge 114 and the bottom side 116) of the top portion 104 may be generally equal to give the top portion 104 a generally square shape. People of skill in the art will appreciate, however, that the top portion 104 may be rectangular or of other shapes. The front surface 104f of the top portion 104 may constitute an inner label and be configured for printing of indicia (e.g., black and white printing, two color printing, four color printing, et cetera). The printing may be effectuated manually or via printing equipment.

The bottom side 116 of the top portion 104 may comprise a first lateral perforated border 118. The first lateral perforated border 118 may also define a top side 120 of the middle portion 106. As explained in more detail below, the first lateral perforated border 118 may allow the top portion 104 to be fully separated from the middle portion 106. The middle portion 106 may also have a left edge 122 and a right edge 124 that are each in line with the left edge 110 and the right edge 112 of the top portion 104, respectively. A width Wm of the middle portion 106 (i.e., the lateral distance between the left edge 122 and the right edge 124 of the middle portion 106) may therefore be generally equal to the width Wt of the top portion 104. Embodiments where the width Wm of the middle portion 106 is less than or greater than the width Wt of the top portion 104 are also contemplated.

A bottom side 126 of the middle portion 106 may extend generally parallel to the top side 120 of the middle portion 106, and may comprise a line of weakness 128. The line of weakness 128 may be formed in the label 100, for example, by scoring, creasing, perforations, et cetera. As discussed in more detail below, the top portion 104 and the middle portion 106 may simultaneously be folded underneath the bottom portion 108 along the line of weakness 128. A height Hm of the middle portion 106 (i.e., the vertical distance between the top side 120 and the bottom side 126 of the middle portion 106), at least in some embodiments, may be less than the height Ht of the top portion 104.

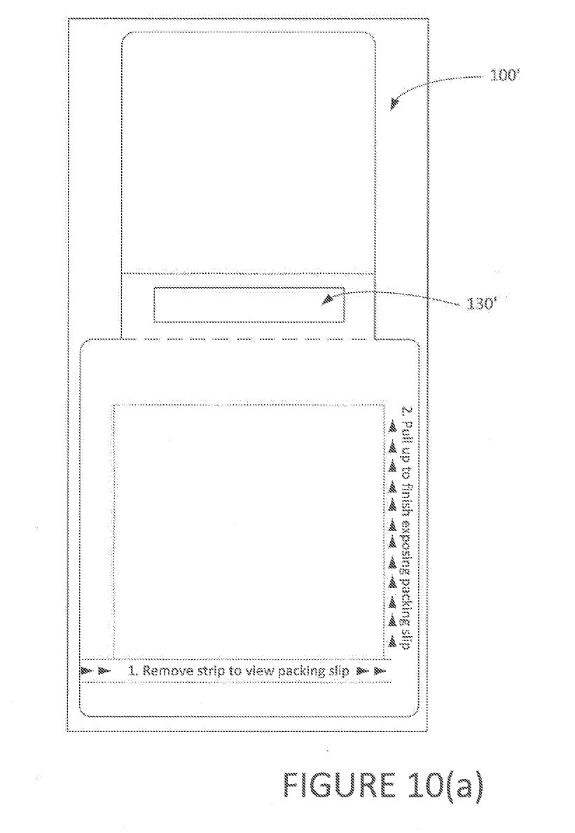

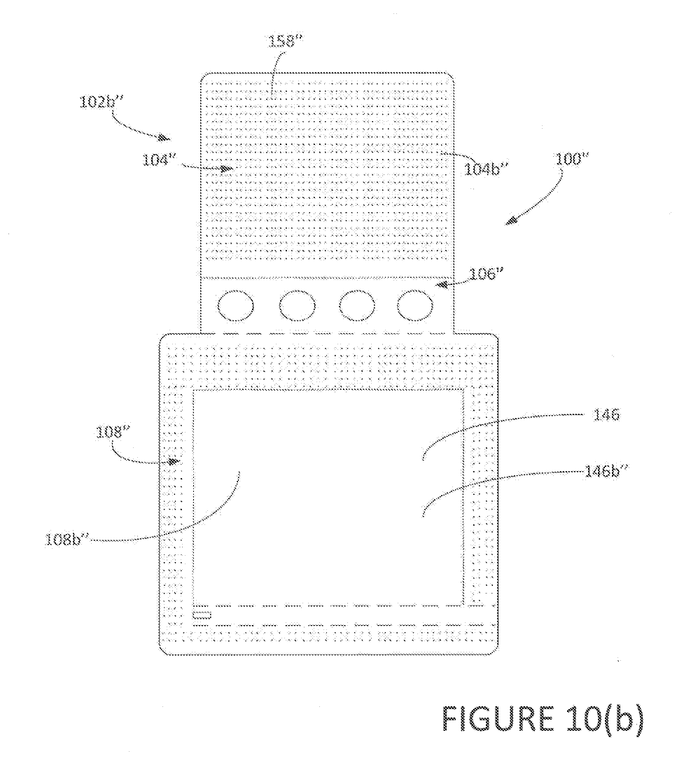

The middle portion 106 may include one or more void spaces or gaps 130 that extend through the front face 106f and the back face 106b of the middle portion 106. As shown in FIG. 1, the gaps 130 may comprise a plurality of circular voids that extend generally evenly through the middle portion 106 between its left edge 122 and right edge 124. However, people of skill in the art will appreciate that the gaps 130 may be of other symmetric (e.g., triangular, rectangular) and non-symmetric shapes, and that all gaps 130 in the middle portion 106 need not be similarly shaped or evenly situated. As an example, FIG. 10 shows a label 100′ in which a gap 130′ comprises a generally rectangular voided strip. In preferred embodiments, the number, placement, shape, et cetera, of the gap(s) 130 may be selected so as to ensure that the gaps 130 are not substantially detrimental to the rigidity and structural integrity of the label 100. The relatively small area of the middle portion 106 may further ensure that the grain is not interrupted in large areas so as to adversely affect the rigidity of the label 100.

The bottom portion 108 may have a left edge 134 and a right edge 136 which may be generally parallel to each other and extend generally vertically. A width Wb (i.e., the lateral distance between the left edge 134 and right edge 136) of the bottom portion 108 may be greater than the width Wm of the middle portion 106 (and particularly width Wt of the top portion 104). The line of weakness 128 may define at least part of a top side 132 of the bottom portion 108. To account for the difference in the width Wb of the bottom portion 108 and the width Wm of the middle portion 106, the top side 132 of the bottom portion 108 may also include a left protruding section 135L and a right protruding section 135R that respectively extend to the left and the right past the left edge 122 and the right edge 124 of the middle portion 106. As can be seen, the top side 132 (i.e., the line of weakness 128, the left protruding section 135L and the right protruding section 135R) may extend generally horizontally, and the perpendicular left edge 134 and right edge 136 of the bottom portion 108 may smoothly merge with the top side 132.

The bottom portion 108 may have a bottom edge 138 that may be generally equal in length to the top side 132 of the bottom portion 108. A tear strip 140 may be provided upwardly adjacent the bottom edge 138 of the bottom portion 108. The tear strip 140 may comprise a second lateral perforated border 142 and a third lateral perforated border 144. As shown in FIG. 1, the tear strip 140 (and the second and third lateral perforated borders 142, 144) may originate at the left edge 134 of the bottom portion 108, extend towards the right edge 136 of the bottom portion 108, and may terminate prior to reaching the right edge 136. Embodiments where the tear strip 140 commences at the right edge 136 of the bottom portion 108 and extends towards but terminates prior to reaching the left edge 134 are also contemplated, as are tear strips 140 that extend the entire width Wb of the bottom portion 108 and are fully separable from the bottom portion 108.

The bottom portion 108 may include an outer label 146 having a front face 146f. The outer label 146 may have a top side defining a fourth lateral perforated border 148. The fourth lateral perforated border 148 may be adjacent and extend generally parallel the top side 132 of the bottom portion 108. The outer label 146 may also have a left side comprising a left vertical perforated border 150, and a right side comprising a right vertical perforated border 152. The left vertical border 150 and the right vertical border 152 may each be adjacent and extend generally parallel the left edge 134 and the right edge 136 of the bottom portion 108, respectively. The outer label 146 may have a bottom side 154 which may correspond to the second lateral perforated border 142. A width Wo of the outer label 146 (i.e., the lateral distance between the left vertical perforated border 150 and the right vertical perforated border 152) may be greater than or equal to the width Wt of the top portion 104. Similarly, a height Ho of the outer label 146 (i.e., the vertical distance between the second lateral perforated border 142 and the fourth lateral perforated border 148) may be greater than or equal to the height Ht of the top portion 104. In preferred embodiments, the width Wt and Height Ht of the top portion 104 may be slightly less than the width Wo and height Ho of the outer label 146, respectively. Further, for reasons that will become clear, a vertical distance Hb between the fourth lateral border 148 and the line of weakness 128 may be generally equal to or slightly less than the height Hm of the middle portion 106.

As can be seen in FIG. 1, the tear strip 140 may include indicia 143 outlining proper usage of the tear strip 140 and the label 100. Additional indicia 145 may be provided between the right vertical perforated border 152 and the right edge 136 of the bottom portion 108, or, for example, between the left vertical perforated border 150 and the left edge 134 of the bottom portion 108.

Attention is now directed to FIG. 2, which shows the back side 102b of the label 100 (i.e., the back face 104b of the top portion 104, the back face 106b of the middle portion 106, and the back face 108b of the bottom portion 108). The back face 104b of the top portion 104 may include an adhesive area 156 adjacent the top edge 114 of the top portion 104. For example, in FIG. 2, the adhesive area 156 is demarcated by an imaginary line AA and the top edge 114, the left edge 110, and the right edge 112 of the top portion 104. The adhesive area 156 may include adhesive (e.g., pressure sensitive adhesive), which may be applied manually, via a printing plate, or by other conventional means now known or later developed. The adhesive may be arranged in the adhesive area 156, for example, in a pattern of symmetrically arranged dots 158 as shown in FIG. 2. People of skill in the art will appreciate, however, that other arrangements are also possible; for example, the adhesive area 156 may comprise a strip of adhesive, or have adhesive arranged in non-symmetric patterns. The label 100 may include a backing sheet 160 (see FIG. 1), which may, for example, be made of paper or synthetic resin and include silicone or another suitable release material to allow the backing sheet 160 to be releasably adhered to the back side 102b of the label 100. The backing sheet 160 may protect the various adhesive portions of the label 100 (e.g., adhesive area 156 and other areas as described below) from inadvertently contacting objects, dust, et cetera. The adhesive area 156 may help ensure that the top portion 104 does not detach from the release liner 160 prematurely. Embodiments that do not include the adhesive area 156 are also contemplated, as discussed in more detail below.

The back face 108b of the bottom portion 108 may include adhesive 162 (e.g., pressure sensitive adhesive), which may be the same or a different adhesive than that applied within the adhesive area 156 on the back face 104b of the top portion 104. Specifically, adhesive 162 may be applied to the back face 108b of the bottom portion 108 between: the top side 132 of the bottom portion 108 and the fourth lateral perforated border 148; the left edge 134 of the bottom portion 108 and the left vertical perforated border 150; the right edge 136 of the bottom portion 108 and the right vertical perforated border 152; and the bottom edge 138 of the bottom portion 108 and the third lateral perforated border 144. As can be seen in FIG. 2, back face 146b of the outer label 146 and back face 140b of the tear strip 140 may not include any adhesive 162.

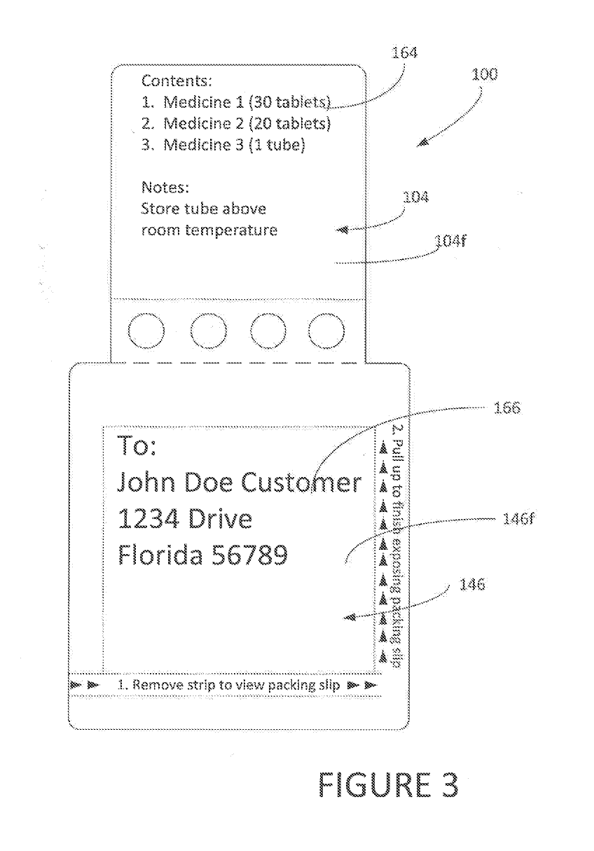

Consider now, for example, that the fold-under label 100 needs to be adhered to a package (or another substrate, e.g., an envelope, container, box, et cetera) being shipped to a customer. Consider also that the fold-under label 100 needs to include sensitive information 164 (e.g., package contents and related instructions) and non-sensitive or public information 166 (e.g., the recipient's shipping address). Attention is now directed to FIG. 3, which shows how such sensitive information 164 and non-sensitive information 166 may be placed on the label 100. Specifically, the sensitive information 164 may be placed on the front surface 104f of the top portion 104 (i.e., the inner label), and the non-sensitive information 166 may be placed on the front surface 146f of the outer label 146. The sensitive information 164 and non-sensitive information 166 may be placed on the label 100 manually (e.g., by a marker or pen), or automatically (e.g., by printing equipment, such as thermal transfer printers or direct thermal printers). As can be seen in FIG. 3, the sensitive information 164 and non-sensitive information 166 on the label 100 may be oriented in one plane, and this printing may advantageously be effectuated by a single print head. In other words, multiple print heads printing in multiple directions is not required.

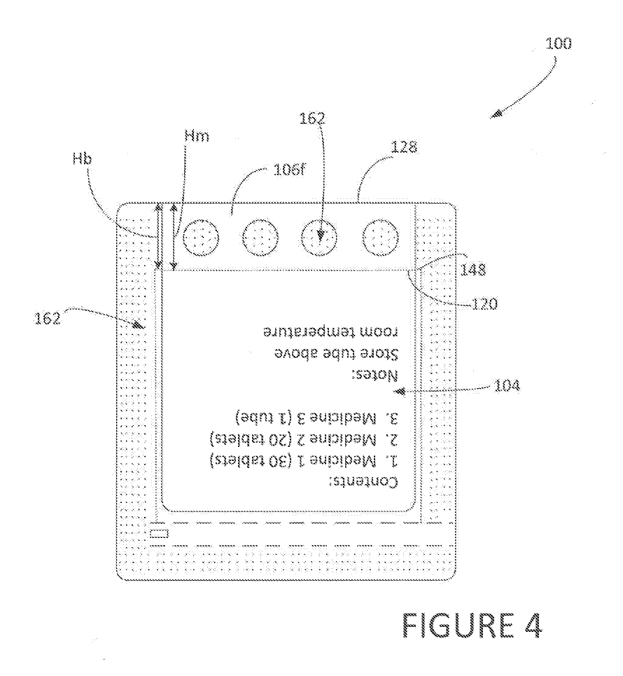

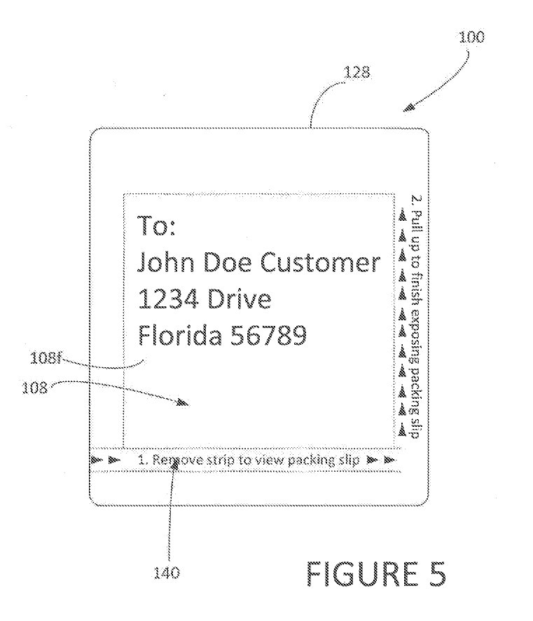

Once the printing has been effectuated, or in some instances before the printing, the fold-under label 100 may be folded in preparation for its application to the substrate. Specifically, as shown in FIGS. 4 and 5, and with reference also to FIGS. 1 and 2, the top portion 104 and middle portion 106 may be folded along the line of weakness 128 such that the back face 104b of the top portion 104 and the back face 106b of the middle portion 106 become adjacent and contact the back face 108b of the bottom portion 108. The back face 146b of the outer label 146 may be fully coated with a release material 169 such as silicone so that contact of the adhesive area 156 in the back face 104b of the top portion 104 (i.e., the inner label) does not cause the top portion 104 to become permanently affixed to the back face 146b of the outer label 146 when the label 100 is folded. Or, for example, the back face 146b of the outer label 146 may be partially coated with the release material 169 (e.g., within a release area 171 (see FIG. 2) in the back face 146b of the outer label 146 that corresponds to the adhesive area 156 in the top portion 104 upon folding). The back face 106b of the middle portion 106, conversely, may not include a release material, and the middle portion 106 may thus be permanently secured to bottom portion 108. As the vertical distance Hb between the fourth lateral border 148 and the line of weakness 128 may be generally equal or slightly less than the height Hm of the middle portion 104, the back face 104b of the top portion 104 may not come into contact with the adhesive 162 between the fourth lateral border 148 and the line of weakness 128.

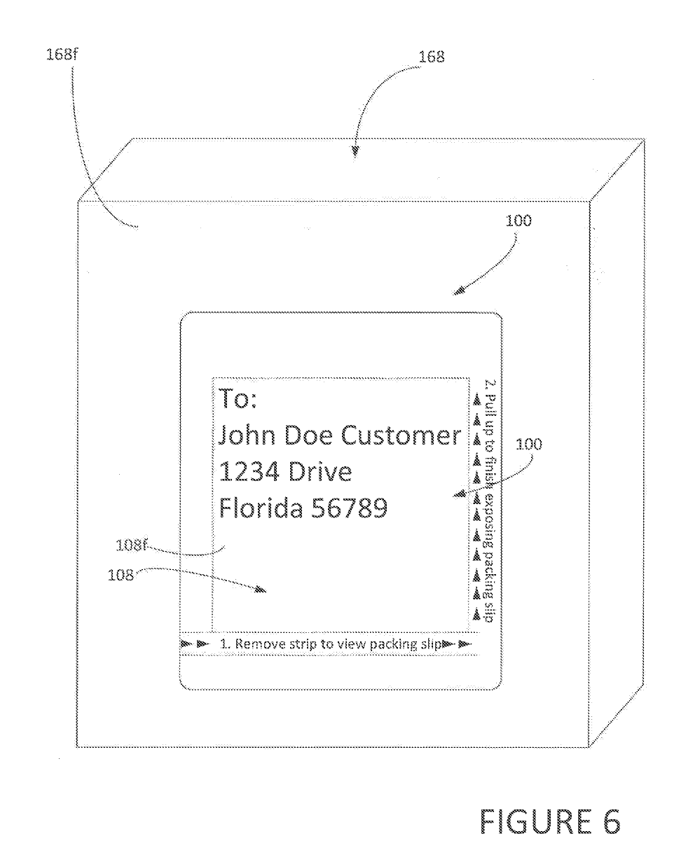

As shown in FIG. 6, after the label 100 is folded in this manner, it may be adhered to a package 168 having a surface 168f such that at least part of the back face 108b of the bottom portion 108 is adjacent and in contact with the surface 168f of the package. Specifically, when the label 100 is so adhered to the package 168, the adhesive 162 (see FIG. 2) on the back face 108b of the bottom portion 108 between the right vertical perforated border 152 and the right edge 136, the left vertical perforated border 150 and the left edge 134, and the third lateral perforated border 144 and the bottom edge 138, collectively interacts with the package surface 168f. Additionally, at least part of the adhesive 162 on the back face 108b of the bottom portion 108 between its top side 132 and the fourth lateral perforated border 148 extends through the middle portion 106 via the void spaces 130 and further interacts with the package surface 168f. Thus, advantageously, in part because of the void spaces 130, all four sides of the back surface 108b of the bottom portion 108 become secured to the package surface 168f. Further, adhesive is only required to be applied to the rear of the label 100.

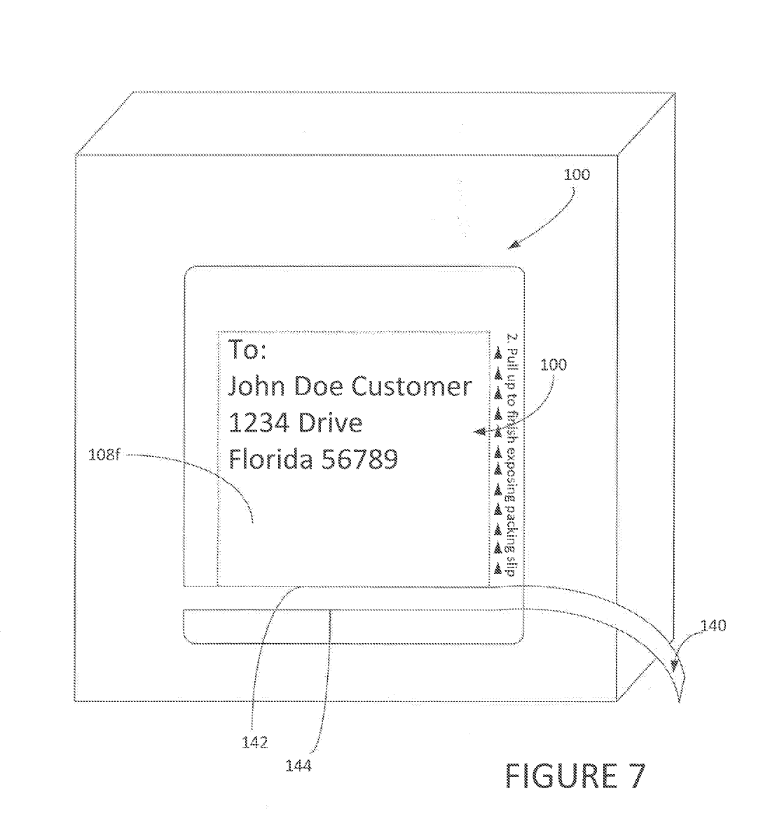

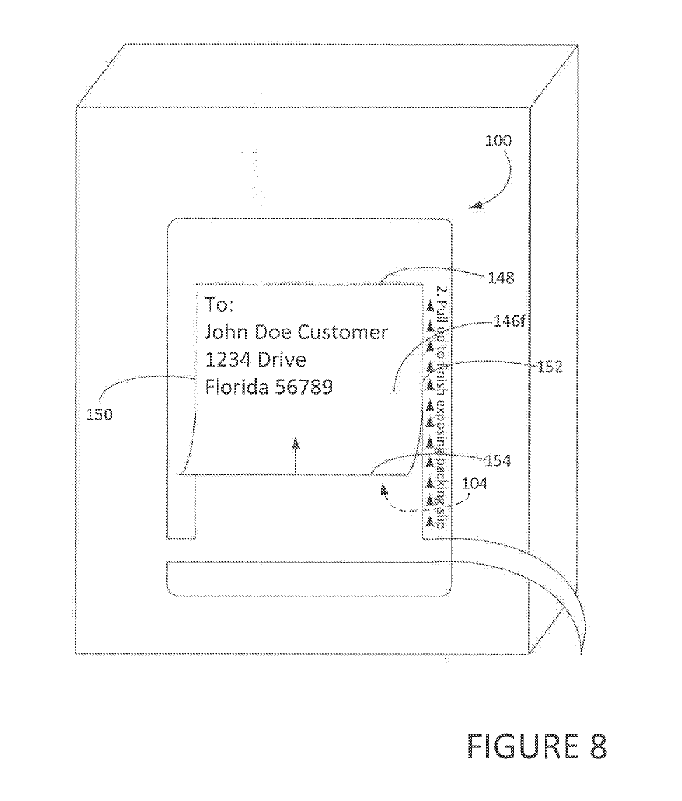

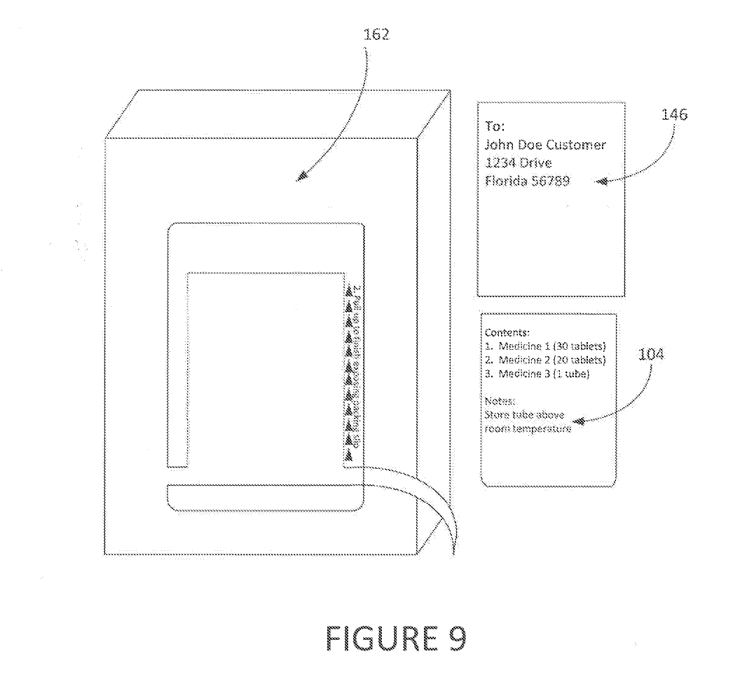

Upon receipt of the package 168, the recipient may tear the tear strip 140 along the second and third lateral perforated borders 142, 144 (see FIG. 7). As can be seen in FIG. 2, the tear strip 140 may not include any adhesive, which may allow the recipient to conveniently access the tear strip 140 at the left edge 134 of the bottom portion 108. Then, as shown in FIG. 8, the recipient may hold the outer label 146 at its bottom side 154 and detach it along the left vertical perforated border 150 and the right vertical perforated border 152. The recipient may then fully detach the outer label 146 along the fourth lateral perforated border 148, and with it, the inner label 104 along the first lateral perforated border 118. Specifically, because of the adhesive area 156, the inner label 104 may remain attached to the outer label 146 as the outer label 146 is being detached. This feature may act as a security feature and ensure that no identifiable markings are left behind on the package 168 once the outer label 146 and the inner label 104 are generally simultaneously removed. As shown in FIG. 9, if desired, the outer label 146 and the inner label 104 may also be separated from each other. People of skill in the art will appreciate, however, that because of the adhesive area 156 on the inner label 104 and the release area 171 on the outer label 146, the inner label 104 may advantageously be releasably secured to the outer label 146 again. This functionality may prevent mix-ups by ensuring that the outer label 146 remains releasably secured to the particular inner label 104 associated with it, and not some other inner label 104 (e.g., an inner label 104 adhered to a different package 168). People of skill in the art will further appreciate that in some embodiments, a separate middle portion 106 may be omitted and the gaps 130 may be provided in the top portion 104.

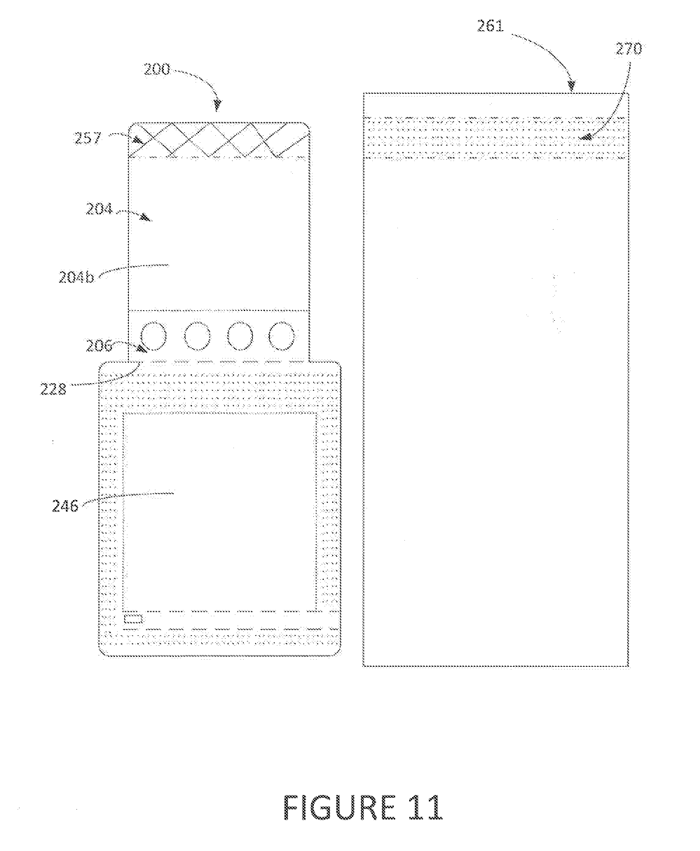

Attention is now directed to FIG. 11, which shows another embodiment 200 of the label 100 that is substantially similar to the embodiment 100, except as specifically noted and/or shown, or as would be inherent. Further, those skilled in the art will appreciate that the embodiment 100 (and thus the embodiment 200) may be modified in various ways, such as through incorporating all or part of any of the various described elements, for example. For uniformity and brevity, reference numbers 200 to 299 may be used to indicate parts corresponding to those discussed above numbered between 100 and 199 (e.g., middle portion 206 corresponds generally to the middle portion 106), though with any noted or shown deviations.

As outlined above, one of the purposes of the adhesive area 156 at the back face 104b of the top portion 104 in the label 100 is to ensure that the top portion 104 does not inadvertently detach from the backing sheet 160 prematurely. In embodiment 200, the adhesive area 156 is absent from top portion 204, and a release area 257 in the back face 204b of the top portion 204 is instead coated with a release material such as silicone. A backing sheet 261, conversely, which as is conventional is otherwise coated with a release material, includes an adhesive portion 270 having adhesive (e.g., pressure sensitive adhesive) that corresponds to the release area 257 when the label 200 is releasably secured to the backing sheet 261. In the embodiment 200, thus, the backing sheet 261 does not detach from the label 200 inadvertently, notwithstanding the fact that the portion of the label 200 above the line of weakness 228 is completely devoid of adhesive.

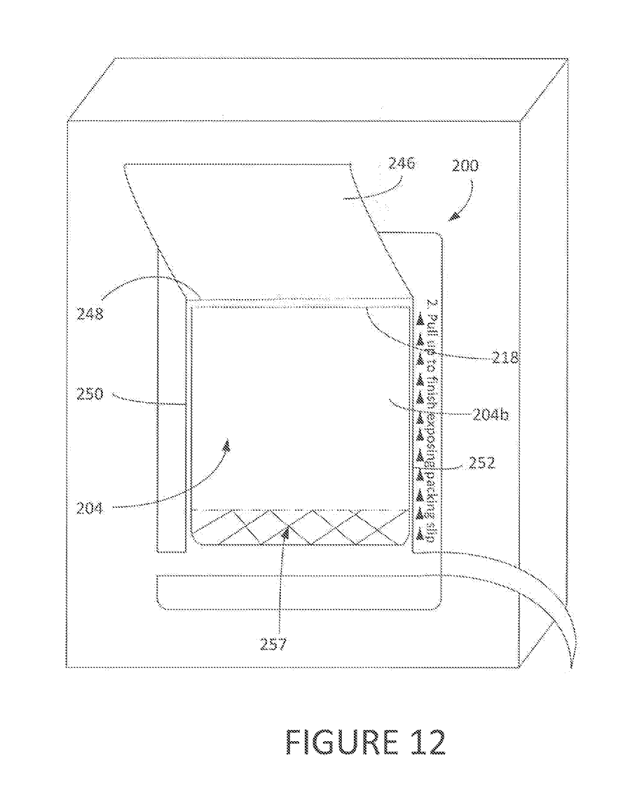

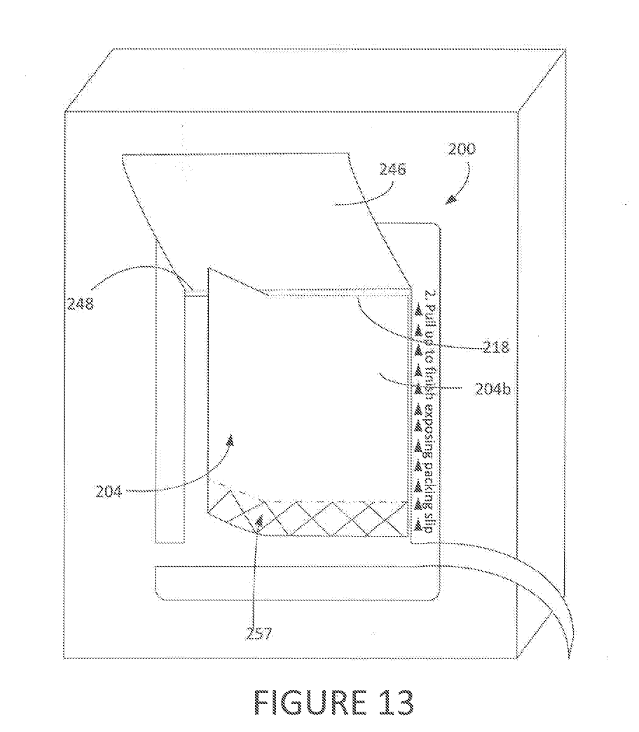

Moreover, because the adhesive area 156 is absent, the outer label 246 and the inner label 204 need not be detached simultaneously. Specifically, as shown in FIGS. 12 and 13, the outer label 246 may be partially detached along the left vertical border 250 and the right vertical border 252, and the inner label 204 may thereafter be detached along the first lateral perforated border 218 without detaching the outer label 246 along the fourth lateral perforated border 248. Embodiment 200, thus, may allow for the outer label 246 to easily remain with the package 268 (e.g., for record keeping). Of course, the outer label 246 may be detached along the fourth lateral border 248 if desired.

Attention is now directed to FIG. 10(b), which shows still another embodiment 100″ of the label 100 that is substantially similar to the embodiment 100, except as specifically noted and/or shown, or as would be inherent. Further, those skilled in the art will appreciate that the embodiment 100 (and thus the embodiment 100″) may be modified in various ways, such as through incorporating all or part of any of the various described elements, for example. For uniformity and brevity, reference numbers 100 to 199 of the embodiment 100 are used (with a ″ designation) to indicate corresponding parts of the embodiment 100″.

The back face 104b of the top portion 104 in embodiment 100 is generally described above as having adhesive 158 within the adhesive area 156. This adhesive 158 corresponds to the release material 169 in the release area 171 in the back face 146b of the outer label 146 when the top portion 104 is folded behind the bottom portion 108, so that the top portion 104 may be subsequently detached from the bottom portion 108, if desired. In embodiment 100″, conversely, the top portion 104″ may be fully covered with the adhesive 158″ to allow the top portion 104″ to be permanently affixed to the back face 146b″ of the outer label 146″ upon folding. Release material 169 (and release area 171) may be absent from the bottom portion 108″ to ensure that the top portion 104″ remains permanently secured to the outer label 146″ when the top portion 104″ is folded behind the bottom portion 108″. Of course, as with embodiment 100, indicia (e.g., sensitive and non-sensitive information) may be provided on both the top portion 104″ and the bottom portion 108″.

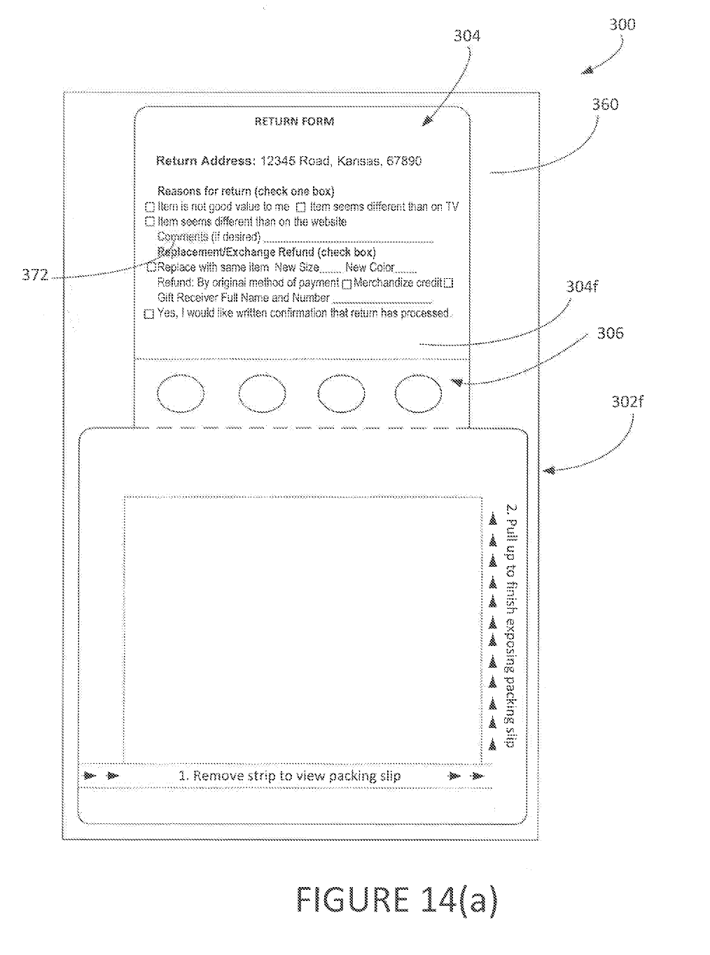

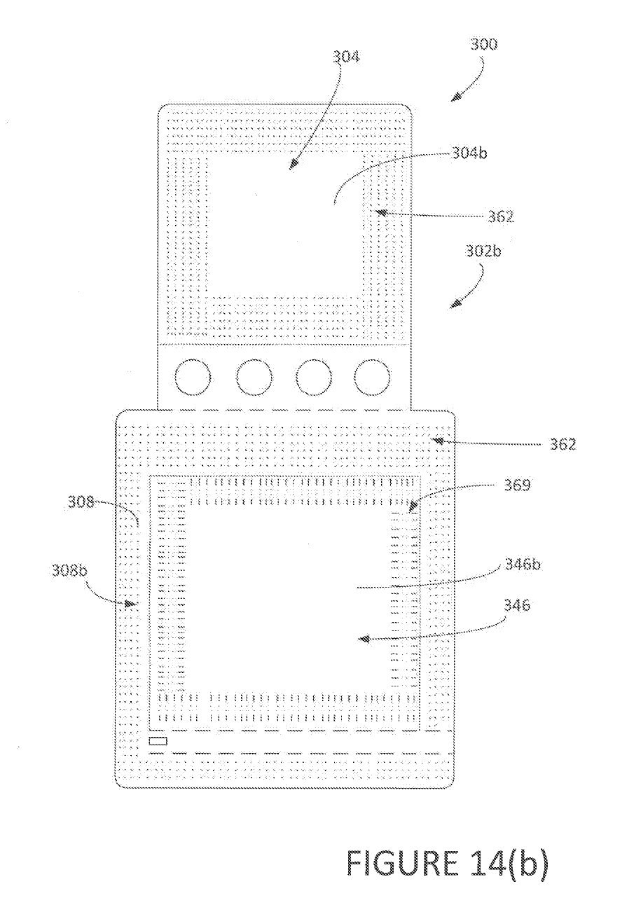

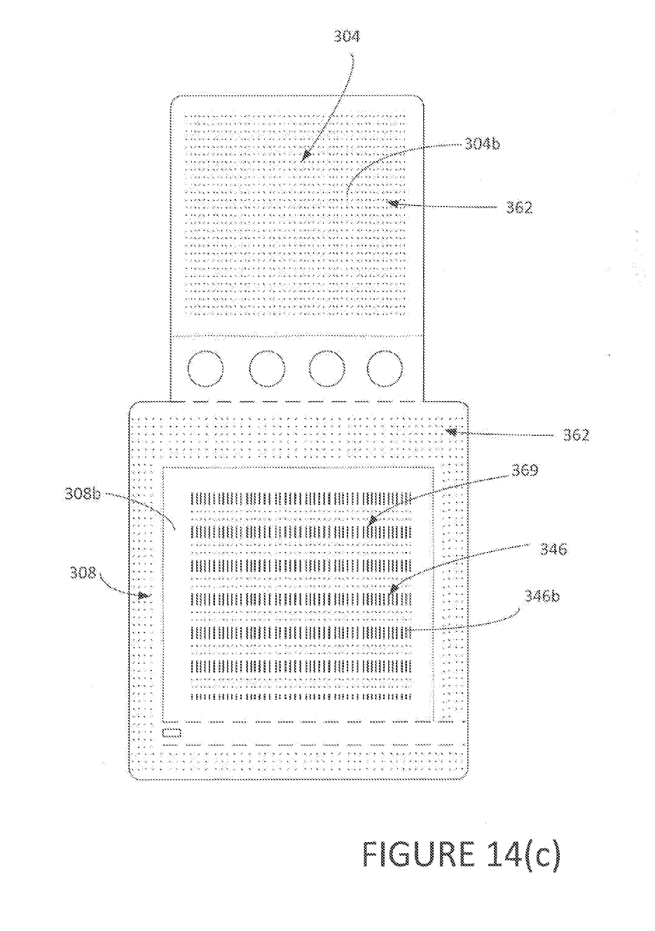

FIGS. 14a-14c show yet another embodiment 300 that is substantially similar to the embodiment 100, except as specifically noted and/or shown, or as would be inherent. Further, those skilled in the art will appreciate that the embodiment 100 (and thus the embodiment 300) may be modified in various ways, such as through incorporating all or part of any of the various described elements, for example. For uniformity and brevity, reference numbers 300 to 399 may be used to indicate parts corresponding to those discussed above numbered between 100 and 199 (e.g., middle portion 306 corresponds generally to the middle portion 106), though with any noted or shown deviations.

The top portion 104 in the embodiment 100 has generally been described above as a packing slip that the sender may use to list, for example, the contents of the package 168 and instructions for the recipient. Top portion 304 of embodiment 300 may alternatively or additionally be used as a return form.

Specifically, every so often, the recipient of the package 368 may be dissatisfied with one or more items in the package 368. This may happen when the seller inadvertently ships to the recipient a package 368 that was intended for another recipient, or for example, when one or more items in the package 368 are defective or are of the wrong size, color, brand, medicinal strength, et cetera. The dissatisfied recipient may wish to return some or all of the items he received to the seller. The seller's return address, however, may sometimes be different than the address from which the package was sent; for example, the items may have been mailed to the recipient from one warehouse, but must be returned at a customer care center that is located elsewhere. The recipient of the package 368, thus, may have to verify the return address separately (for example, through online research). The recipient may also want to include with the returned item(s) notes for the seller. For example, the recipient may wish to outline the reasons for his dissatisfaction with the contents of the package 368. Or, for example, the recipient may wish to convey to the seller that he is owed a refund, or that the seller may ship alternate item(s) in exchange for the defective item(s). The recipient may then send the item(s) or the entire package 368 back to the seller with a new shipping label.

Verifying the seller's return address, creating a new shipping label, and crafting a note (or making a phone call) to convey the reasons for returning the item(s) may take additional effort on part of the dissatisfied recipient, and may cause the recipient additional distress. Top portion 304 (i.e., the inner label) of the label 300 may comprise a return form to address such problems. FIG. 14(a) shows front side 302f of the label 300. As can be seen, front face 304f of the top portion 304 of the label 300 may have pre-printed thereon the address at which the recipient of the package 368 may return items. The front face 304f may also have other indicia 372 that may be customized to meet the seller's or recipient's requirements. For example, the indicia 372 may include potential reasons due to which recipients generally return the content(s) of the package 368, and/or the steps that the recipient wishes for the seller to take return (e.g., refund the price via cash or credit card, or replace the item with one of a different size, color, et cetera).

FIG. 14(b) shows back side 302b of the label 300. Unlike the back face 104b of the top portion 104 of label 100 which may contain adhesive only within the adhesive area 156, or the back face 204b of top portion 204 of the label 200 which is devoid of any adhesive, the back face 304b of the top portion 304 of label 300 may include adhesive 362 on all sides (or alternatively, be fully covered with adhesive, or be covered with adhesive except at its sides as shown in FIG. 14(c)). Back face 346b of outer label 346 may be coated with release material 369 (e.g., fully, on all sides as shown in FIG. 14(b), or otherwise corresponding to the adhesive 362 in the top portion as shown in FIG. 14(c)) so that the top portion 304 does not get permanently affixed to the bottom portion 308 when the label 300 is folded and utilized by the seller to ship the package 368 to the recipient. Upon receipt of the package 368, the recipient may remove the outer label 346 and the inner label 304 from the label 300 as discussed above with respect to embodiment 100. Then, if the recipient wishes to return some or all of the items in the package 368 to the seller, he may adhere the top portion 304 to the return package via the adhesive 362. People of skill in the art will appreciate that top portion 304 may also include contents of the package 368 and instructions for the recipient, as discussed with respect to the top portion 104 of label 100.

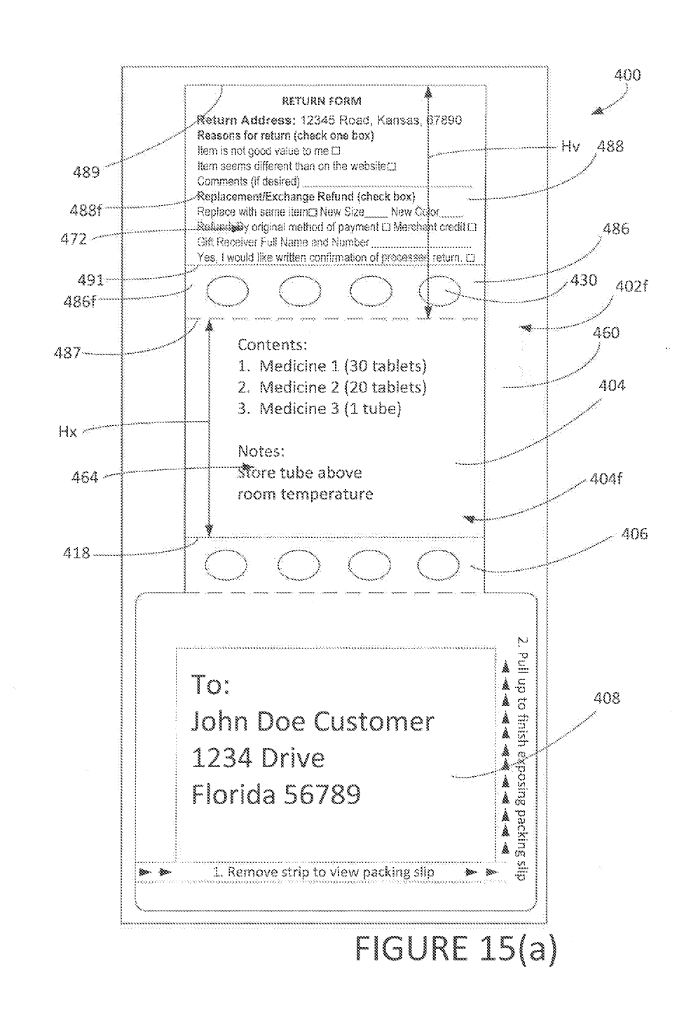

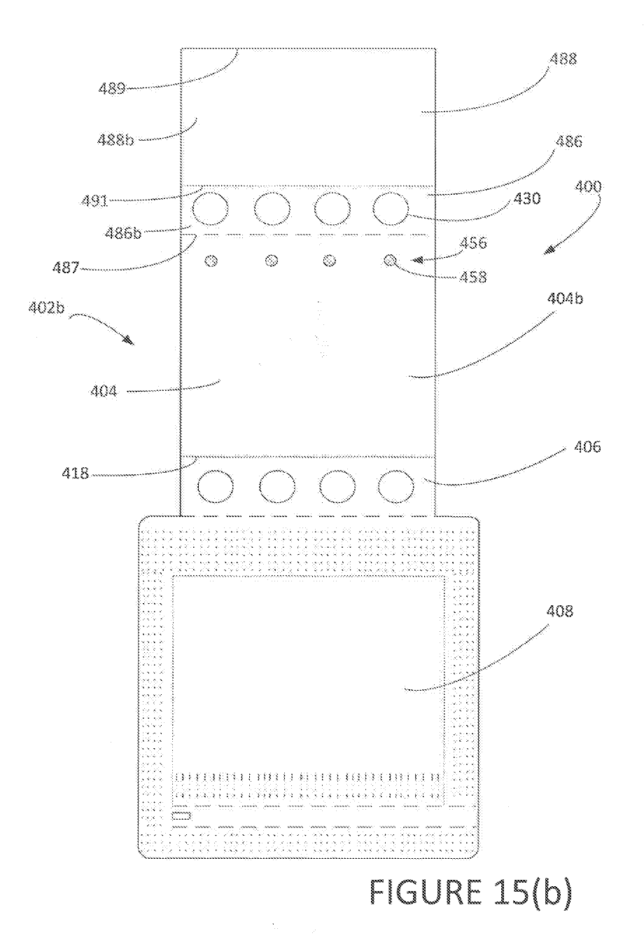

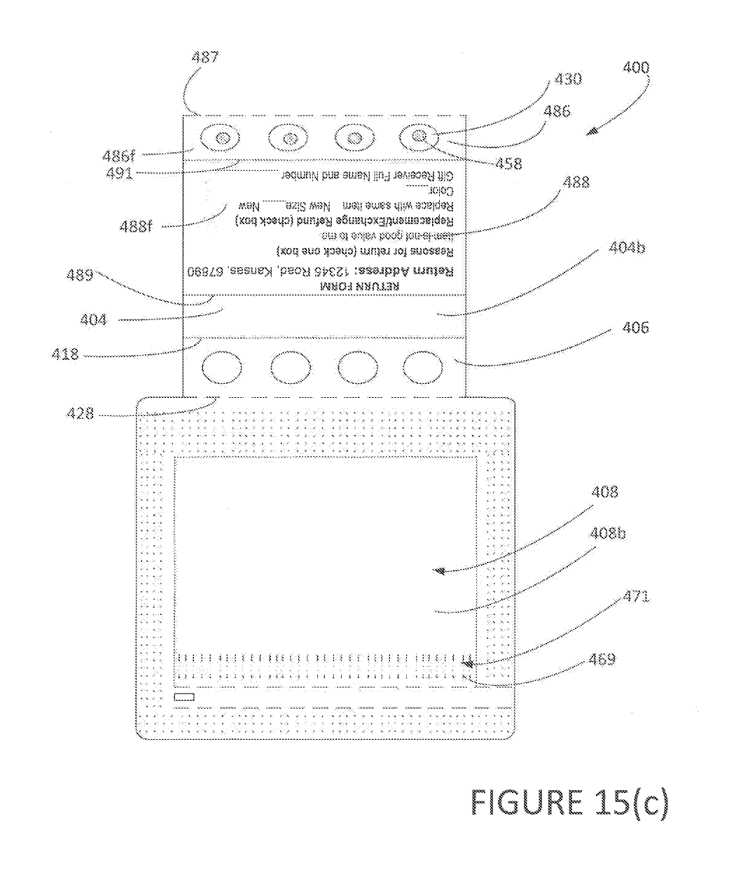

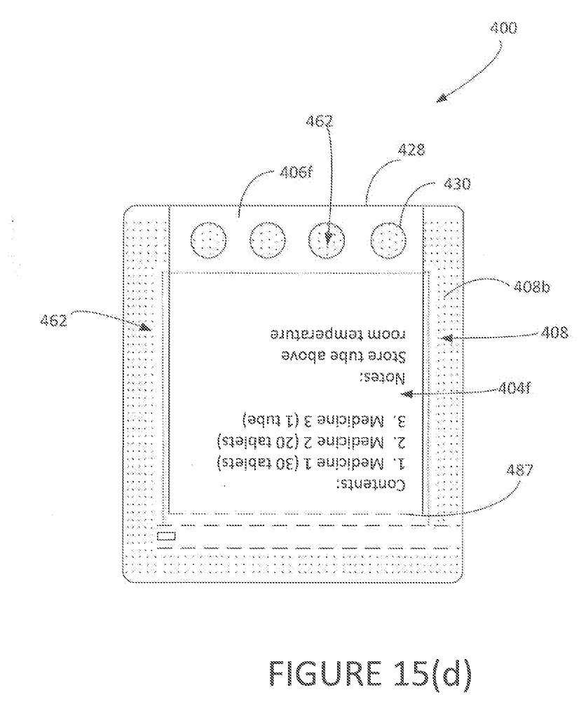

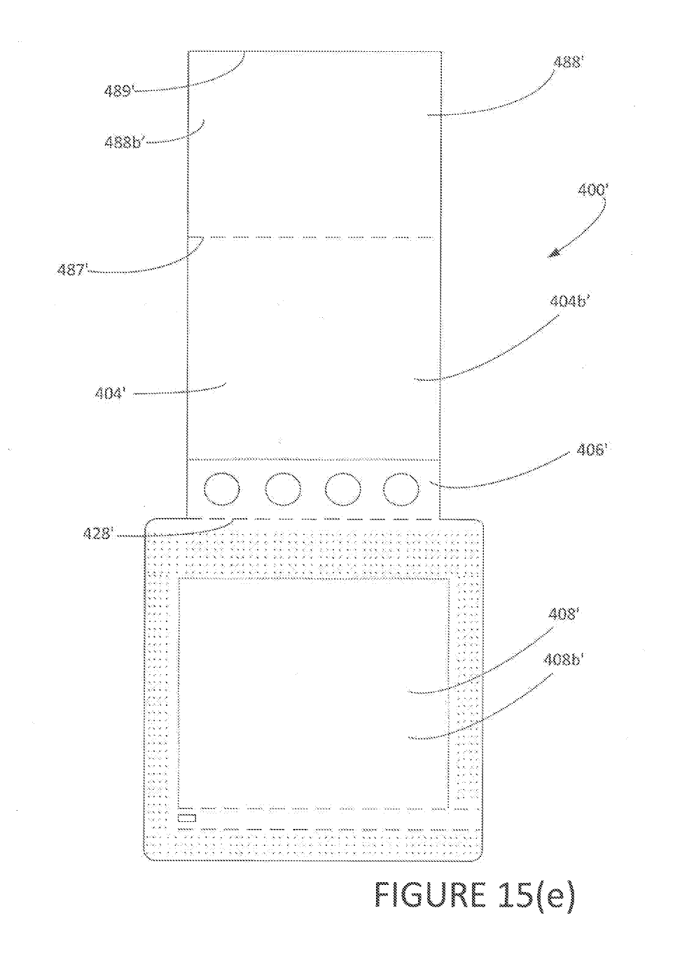

FIGS. 15(a)-15(d) show yet another embodiment 400 that is substantially similar to the embodiment 100, except as specifically noted and/or shown, or as would be inherent. Further, those skilled in the art will appreciate that the embodiment 100 (and thus the embodiment 400) may be modified in various ways, such as through incorporating all or part of any of the various described elements, for example. For uniformity and brevity, reference numbers 400 to 499 may be used to indicate parts corresponding to those discussed above numbered between 100 and 199 (e.g., middle portion 406 corresponds generally to the middle portion 106), though with any noted or shown deviations.

In embodiment 300, the top portion 304 served as the return form. While the sensitive information 364 can be placed on the return form 304, a recipient of the package 368 may desire for the sensitive information 364 to be placed elsewhere so that the recipient can utilize the return form 304 with a return package without including the sensitive information 364. The label 400 may provide this functionality. As can be seen in FIG. 15(a), the label 400 may have a bottom portion 408, a middle portion 406, and a top portion 404 that generally correspond to the bottom portion 108, the middle portion 106 and the top portion 104 of the label 100. A fourth portion 486, which may generally correspond to the middle portion 406 and have gaps 430 extending therethrough, may extend from the top portion 404 away from the bottom portion 408. The fourth portion 486 may have a front face 486f and a back face 486b. A second line of weakness 487 may separate the top portion 404 from the fourth portion 486.

A fifth portion 488, which may generally correspond to the return form 304 of embodiment 300, may extend from the fourth portion 486 away from the bottom portion 408 and terminate at an upper edge 489. A fifth lateral perforated border 491 may separate the fourth portion 486 from the fifth portion 488. The fifth portion 488 may have a front face 488f and a back face 488b. While not required, a combined height Hv of the fourth portion 486 and the fifth portion 488 (i.e., a vertical distance between the upper edge 489 and the second line of weakness 487) may be less than or equal to a height Hx of the top portion 404 (i.e., a vertical distance between the second line of weakness 487 and the first lateral perforated border 418). Sensitive information 464 may be provided on the front face 404f of the top portion 404. The recipient's name, address, et cetera, may be provided on the front face 408f of the bottom portion 408. Indicia 472, which may for example include the seller's return address, potential reasons due to which recipients generally return the content(s) of the package 468, and/or the steps that the recipient wishes for the seller to take (e.g., refund the price via cash or credit card, or replace the item with one of a different size, color, et cetera), may be provided on the front face 488f of the fifth portion 488.

FIG. 15(b) shows the back side 402b of the label 400 after the liner 460 has been removed. As can be seen, the back face 404b of the top portion 404 may include the adhesive area 456 having adhesive 458 akin to the adhesive area 156 of the label 100. When the label 400 is to be secured to the package 468, the fourth portion 486 and the fifth portion 488 may first be simultaneously folded along the second line of weakness 487 such that the back face 486b of the fourth portion 486 and the back face 488b of the fifth portion 488 are adjacent and in contact with the back face 404b of the top portion 404. As can be seen in FIG. 15(c), when so folded, the adhesive 458 in the adhesive area 456 of the top portion 404 may extend through the gaps 430 in the fourth portion 486. Further, because the combined height Hv (see FIG. 15(a)) of the fourth portion 486 and the fifth portion 488 may be less the height Hx of the top portion 404, the fifth portion 488 (including its upper edge 489) may not contact and impede the functionality of the middle portion 406.

After the fourth portion 486 and the fifth portion 488 have been simultaneously folded behind the top portion 404 as in FIG. 15(c), the middle portion 406 and the top portion 404, along with the fourth portion 486 and the fifth portion 488, may be simultaneously folded along the line of weakness 428 behind the bottom portion 408 such that at least part of the front face 488f of the fifth portion 488 (i.e., the return form) is adjacent and in contact with the back face 408b of the bottom portion 408 (see FIG. 15(d)). In this configuration, as described with respect to the label 100, the adhesive 462 at the back face 408b of the bottom portion 408 may extend through the gaps 430 of the middle portion 406, and allow the label 400 to be adhered on all four sides to the package 468. While not clearly shown in the figures, people of skill in the art will appreciate that the adhesive 458 (see FIG. 15(b)) in the adhesive area 456 of the top portion 404 may extend through the gaps 430 in the fourth portion 486 and contact the release material 469 in the release area 471 (see FIG. 15(c)), thereby ensuring that the label 400 does not inadvertently unfold before it is secured to the package 468. Embodiments where the fifth portion 488 extends directly from the top portion 404 (i.e, where the fourth portion 486 is absent) are also contemplated, as discussed below.

As described with respect to other embodiments, upon receipt of the package 468, the recipient may tear the tear strip 440 and detach the bottom portion 408 and the top portion 404 (along with the fourth portion 486 and the fifth portion 488 that are folded behind the top portion 404), leaving no identifiable markings behind on the package 468. The recipient may (or may not) subsequently detach the fifth portion 488 along the fifth lateral perforated border 491 from the fourth portion 486. The recipient may also detach the top portion 404 from the fourth portion 486 and the middle portion 406 along the second line of weakness 487 and the first lateral perforated border 418, respectively.

Focus is now directed to FIG. 15(e), which shows another embodiment 400′ of the embodiment 400 that is substantially similar to the embodiment 400, except as specifically noted and/or shown, or as would be inherent. Further, those skilled in the art will appreciate that the embodiment 400 (and thus the embodiment 400′) may be modified in various ways, such as through incorporating all or part of any of the various described elements, for example. For uniformity and brevity, reference numbers 400 to 499 of the embodiment 400 are used (with a ′ designation) to indicate corresponding parts of the embodiment 400′.

The fifth portion 488 may extend from the fourth portion 486 in embodiment 400. In embodiment 400′, conversely, the fifth portion 488′ may extend directly from the top portion 404′. The top portion 404′ and the fifth portion 488′ may be separated by the second line of weakness 487′, while the fifth lateral perforated border 491, the fourth portion 486 and/or the gaps 430 therein may be absent. When the label 400′ is to be secured to a substrate (e.g., a package, envelope, et cetera), the fifth portion 488′ may be folded along the second line of weakness 487′ behind the top portion 404′ such that the back face 488b′ of the fifth portion 488′ is adjacent and in contact with the back face 404b′ of the top portion 404′. A height of the fifth portion 488′ may configured such that the upper edge 489′ of the fifth portion 488′ does not extend up to the middle portion 406′ when the fifth portion 488′ is folded behind the top portion 404′. As the back face 404b′ of the top portion 404′, unlike embodiment 400, may be devoid of the adhesive 458 (see FIG. 15(e)), the top portion 404′ and the fifth portion 488′ may not become permanently affixed to each other. The top portion 404′ and the middle portion 406′, along with the fourth portion 488′ that is tucked behind the top portion 404′, may then be folded underneath the bottom portion 408′ along the line of weakness 428′ such that the front face 488f (not specifically shown) of the fifth portion 488′ is adjacent and in contact with the back face 408b′ of the bottom portion 408′. The middle portion 406′ may function akin to the middle portion 406 of embodiment 400 to allow the back face 408b′ of the bottom portion 408′ to be secured to a substrate on all sides.

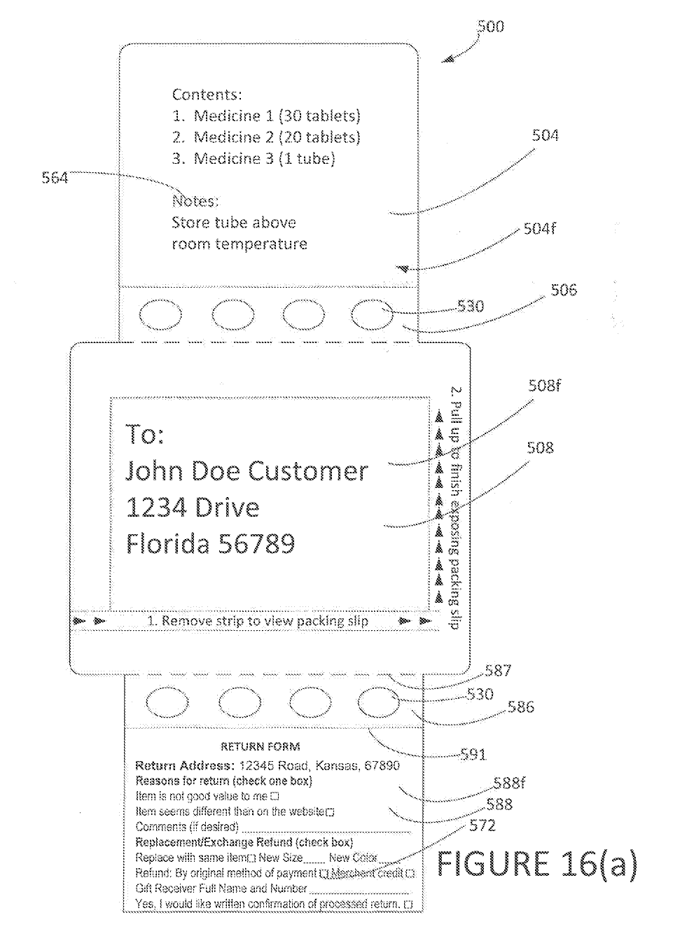

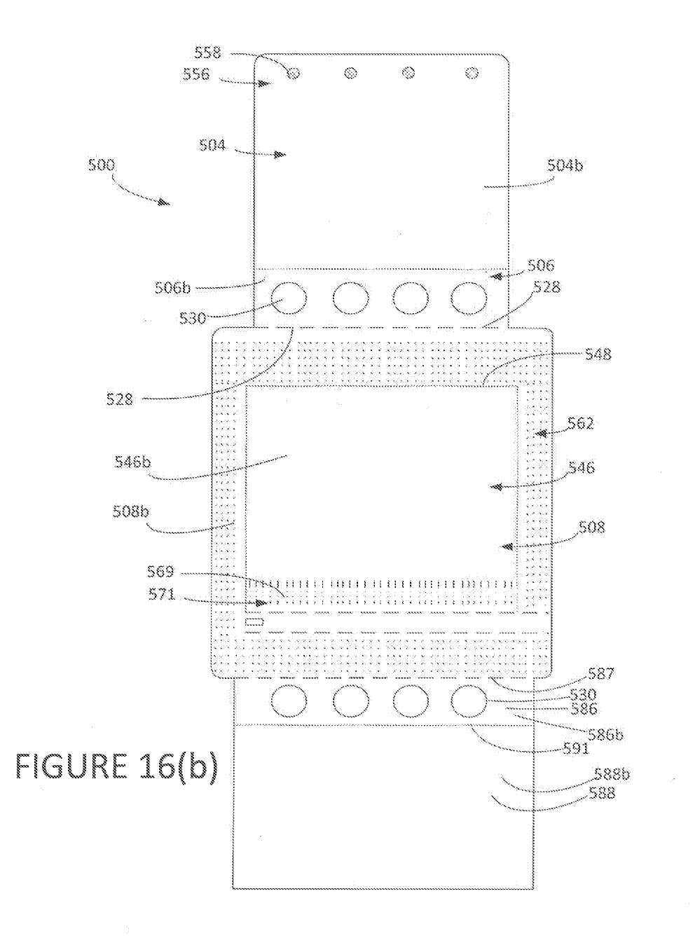

Attention is now directed to FIGS. 16(a)-16(b), which shows yet another embodiment 500 that is similar to the embodiment 100, except as specifically noted and/or shown, or as would be inherent. Further, those skilled in the art will appreciate that the embodiment 100 (and thus the embodiment 500) may be modified in various ways, such as through incorporating all or part of any of the various described elements, for example. For uniformity and brevity, reference numbers 500 to 599 may be used to indicate parts corresponding to those discussed above numbered between 100 and 199 (e.g., middle portion 506 corresponds generally to the middle portion 106), though with any noted or shown deviations.

In label 400, the fourth portion 486 extended from the top portion 404 away from the bottom portion 408. In label 500, conversely, a sixth portion 586, which may be similar to the fourth portion 486 of the label 400 and have gaps 530, may extend from the bottom portion 508 away from the top portion 504. A seventh portion 588, which may be similar to the fifth portion 488 of the label 400, may extend from the sixth portion 586 away from the top portion 504. A third line of weakness 587 may separate the sixth portion 586 from the bottom portion 508, and a sixth lateral perforated border 591 may separate the sixth portion 586 from the seventh portion 588. Sensitive information 564 may be provided on the front face 504f of the top portion 504. The recipient's name, address, et cetera, may be provided on the front face 508f of the bottom portion 508. Indicia 572, which may for example include the seller's return address, potential reasons due to which recipients generally return the content(s) of the package 568, et cetera, may be provided on a front face 588f of the seventh portion 588.

When the label 500 is to be adhered to the package 568, the top portion 504 and the middle portion 506 may be simultaneously folded along the line of weakness 528 behind the bottom portion 508 such that the back face 504b of the top portion 504 and the back face 506b of the middle portion 506 are adjacent and in contact with the back face 504b of the bottom portion 504. In this configuration, the adhesive 558 in the adhesive area 556 of the top portion 504 may interact with the release material 569 in the release area 571 of the bottom portion 508. The sixth portion 586 and the seventh portion 588 may then be simultaneously folded along the third line of weakness 587 behind the bottom portion 508 (and the top portion 504 and the middle portion 506 that have already been folded behind the bottom portion 508). The bottom portion 508, in part because of the gaps 530 in the middle portion 506 and the gaps 530 in the sixth portion 586, may then be secured via the adhesive 562 to all side of the package 568. People of skill in the art will appreciate that in some embodiments the top portion 504 and the middle portion 506 may be folded behind the bottom portion 508 after the folding of the sixth portion 586 and the seventh portion 588. In these embodiments, the adhesive 558 in the adhesive area 556 and the release material 569 in the release area 571 may be omitted. Alternatively, the seventh portion 588 may include adhesive so that the recipient may utilize the seventh portion 588 as a return form without additional adhesive, and the back face 546b of the outer label 546 may include the release material 569 that corresponds to the adhesive on the seventh portion 588 upon folding so as to ensure that the seventh portion 588 does not become permanently secured to the outer label 546.

Upon receipt of the package 568, the recipient may tear the tear strip 540 and detach the top portion 504 and the bottom portion 508 (along with the sixth portion 586 and the seventh portion 588), leaving no identifiable markings behind on the package 568. The recipient may also detach the seventh portion 588 along the sixth lateral perforated border 591 from the sixth portion 586, and use the seventh portion 588 as a return form.

It may be desirable in certain situations for sellers (e.g., retailers and manufacturers) to include a card 695 (e.g., discount card, membership card, credit card, gift card, et cetera) with the package 668 being shipped to a recipient. The card 695 may be placed within the package 668 along with its other contents. However, the card 695 may be overlooked (e.g., because of its small size) and/or inadvertently discarded with the packaging. Sellers, therefore, may send the card 695 to the recipient in a separate package or envelope. However, separate shipping of the card may unnecessarily add to the shipping costs. It may thus be beneficial to include the card 695 with a fold-under label.

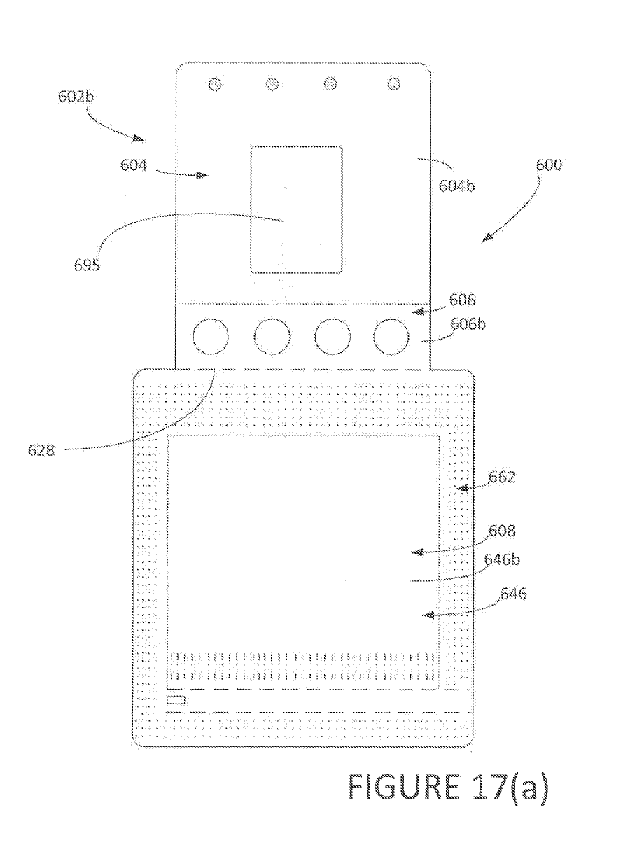

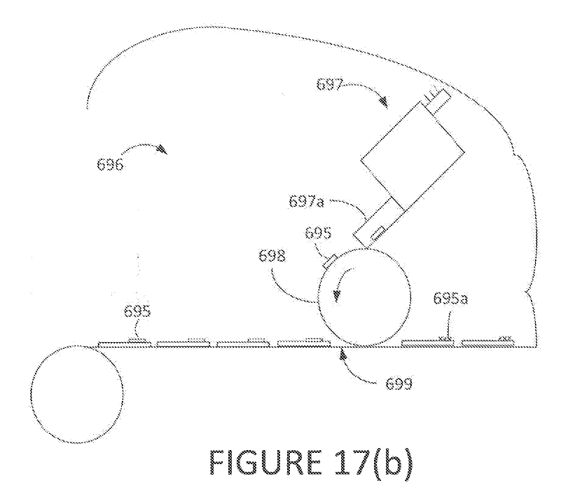

Attention is now directed to FIG. 17(a), which shows another embodiment 600 that is similar to the embodiment 100, except as specifically noted and/or shown, or as would be inherent. Further, those skilled in the art will appreciate that the embodiment 100 (and thus the embodiment 600) may be modified in various ways, such as through incorporating all or part of any of the various described elements, for example. For uniformity and brevity, reference numbers 600 to 699 may be used to indicate parts corresponding to those discussed above numbered between 100 and 199 (e.g., middle portion 606 corresponds generally to the middle portion 106), though with any noted or shown deviations.

One of the key differences between the embodiment 100 and the embodiment 600 is that the label 600, at the back face 604b of the top portion 604, includes the card 695. The card 695 may be releasably secured to the back face 604b of the top portion 604 with a removable or repositionable adhesive 695a (FIG. 17(b)) before the top portion 604 and the middle portion 606 are simultaneously folded along the line of weakness 628. Upon folding of the top and middle portions 604, 606, the card 695 may become adjacent and contact the back face 608b of the bottom portion 608 (and more specifically, the back face 646b of the outer label 646, which, as discussed above, may be devoid of the adhesive 662). When the recipient receives the package 668, he may detach the outer label 646 and the top portion 604 as discussed above with respect to embodiment 100, and separate the card 695 from the top portion 604. While not required, the label 600 may include indicia outlining that the card 695 is provided with the label 600.

The card 695 may be releasably secured to the back face 646b of the outer label 646 manually. Alternatively, the process of releasably securing the cards 695 to the labels 600 may be automated. For example, a card placing apparatus 696 (FIG. 17(b)) may be used to automatically secure the cards 695 to the back face 604b of the top portion 604. The card placing apparatus 696 may include a hopper 697, a card placement roller 698, and feeding means 699 (e.g., a belt). A feeding attachment 697a may be operably coupled to the hopper 697. The cards 695 may be placed in the hopper 697, and fed via the feeding attachment 697a to the card placement roller 698. The feeding means 699 may cause a plurality of labels 600 having the adhesive 695a on the back face 604b of the top portion 604 to successively become adjacent the placement roller 698. The placement roller 698 may be configured to rotate and place one card 695 on the back face 604b of the top portion 604 of each successive label 600 being fed by the feeding means 699.

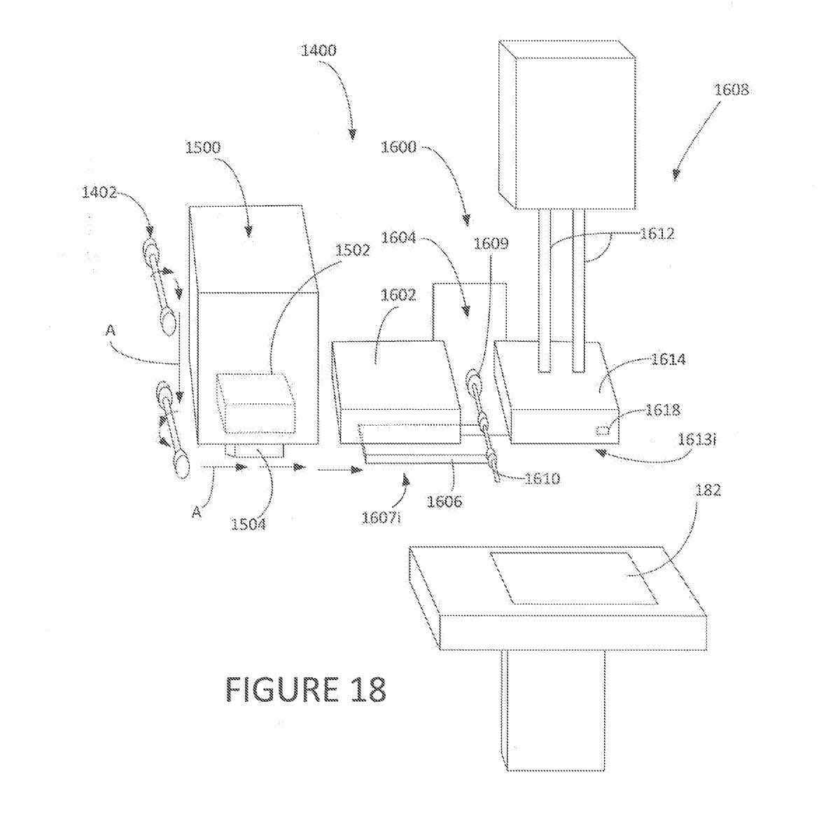

Heretofore, generally, fold-under labels have had to be manually folded and applied to respective packages 168. As can be appreciated, such manual folding and application may be time intensive and laborious. The label 100, with its relatively rigid design, may be configured to be automatically applied to the package 168 (or another substrate) by a print and apply machine 1400. Specifically, the print and apply machine 1400 may allow the label 100 (and other fold under labels) to be automatically printed, folded, and applied to the package 168. Attention is directed to FIG. 18.

Print and apply machine 1400 may include a printing apparatus 1500 and a folding/application apparatus 1600. The label 100 may be fed to the printing apparatus 1500 and the folding/application apparatus 1600 in direction A either in a continuous web of labels 100 or separately. The feeding mechanism may include rollers 1402, which may but need not be motorized. Alternatively, or in addition, other conventional feeding mechanisms may be utilized (e.g., belts). Printing on the label 100 may first be effectuated by the printing apparatus 1500, and the label 100 may thereafter be fed to the folding/application apparatus 1600.

The printing apparatus 1500 may comprise a printer 1502 which may be any impact or non-impact printer, such as a direct thermal printer, a thermal transfer printer, et cetera. The printer 1502 may have a single print head 1504 that prints both the sensitive information 164 on the front surface 104f of the inner label 104 and the non-sensitive information 166 on the front surface 146f of the outer label 146. The backing sheet 160 may be removed from the label 100 either before or after the printing by conventional means. Where the backing sheet 160 is removed prior to printing, the feeding mechanism (e.g., rollers 402) may be coated with a release material. Once the printing is complete, the label 100 may be fed to the folding/application apparatus 1600.

The folding/application apparatus (or station) 1600 may include a stop 1602, a folding portion 1604 having a folding arm 1606, and an application portion 1608. The folding portion 1604 may include a rotating member 1609. The rotating member 1609 may be configured to rotate, and may be actuated in any one of a number of ways. For example, the rotating member 1609 may be actuated by a battery powered or other type of motor, a solenoid, gears, springs, pressurized gas (including air), pressurized fluid, et cetera.

The rotating member 1609 may be directly or indirectly coupled to the folding arm 1606. For example, a rod 1610 may extend from the rotating member 1609, and the folding arm 1606 may be operably coupled to the rod 1610. The folding arm 1606, which is shown in an initial position 1607i in FIG. 18, may be rectangular as shown or of other regular or irregular shapes, and may be made of metal, metal alloys, plastics, or other desirable materials. As discussed in more detail below, actuation of the rotatable member 1609 may cause the folding arm 1606 to fold the label 100.

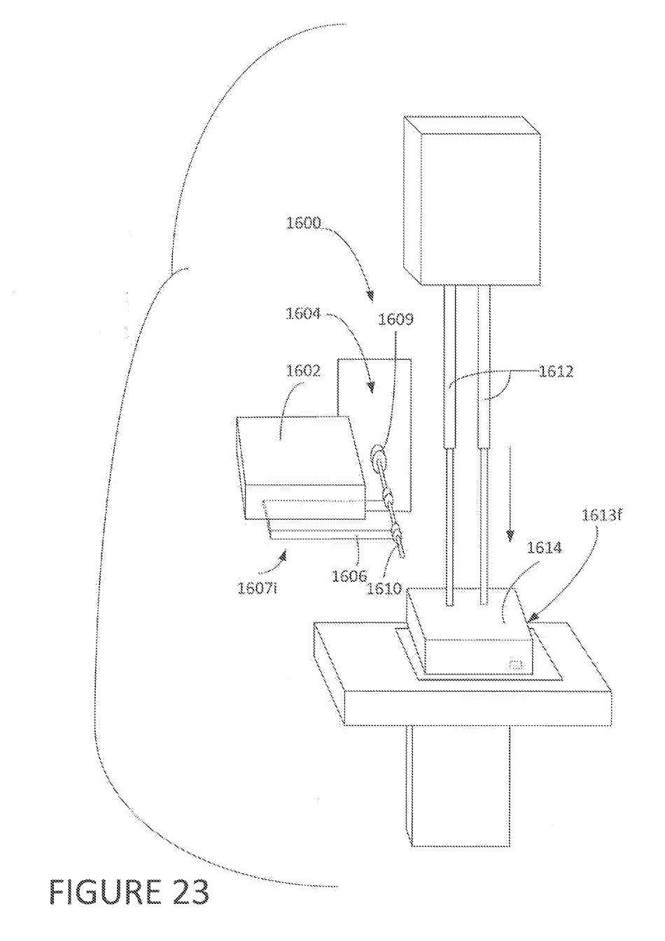

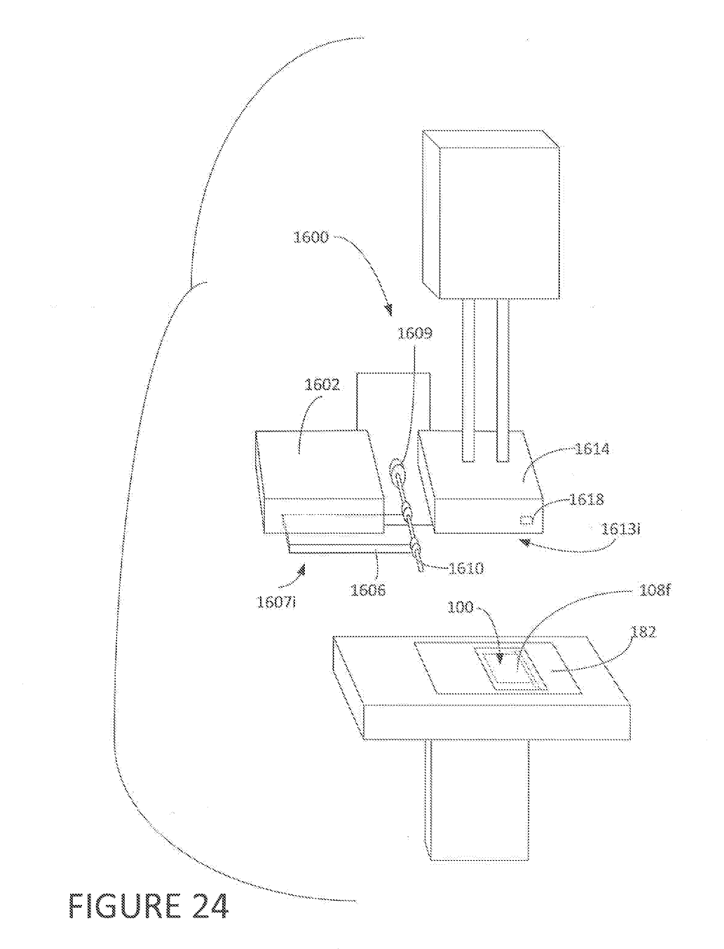

The application portion 1608 may have one or more extendable members, which may for example comprise rods 1612 operably coupled to a pneumatic cylinder. An affixing member 1614 (e.g., a plate) may be secured to the rods 1612 and be configured to move from an initial position 1613i to a final position 1613f (FIG. 23) when the extendable rods 1612 extend downward. The affixing member 1614 may include vacuum nozzles connected to a vacuum source to hold the label 100 against the affixing member 1614, and a programmable logic controller or other timing control circuit having a sensor 1618. The sensor 1618 may be configured to read a timing mark 180 on the back face 102b of the label 100 (see FIG. 2). While the timing mark 180 has been shown in the figures as being on the back face 140b of the tear strip 140, people of skill in the art will appreciate that the timing mark 180 may be placed elsewhere on the back face 102b of the label 100.

An envelope 182 (or another substrate such as the package 168) may be placed underneath the affixing member 1614, and the print and apply apparatus 1400 may cause the label 100 to be printed, folded, and secured to the envelope 182 as discussed below. While the envelope 182 is shown in the figures as resting on a bench, people of skill the art will appreciate that the envelope 182 may be brought underneath the affixing member 1614 in other ways (e.g., by conveyer belts that transport the envelope 182 and successively replace one envelope 182 to which the label 100 has been affixed with another envelope 182).

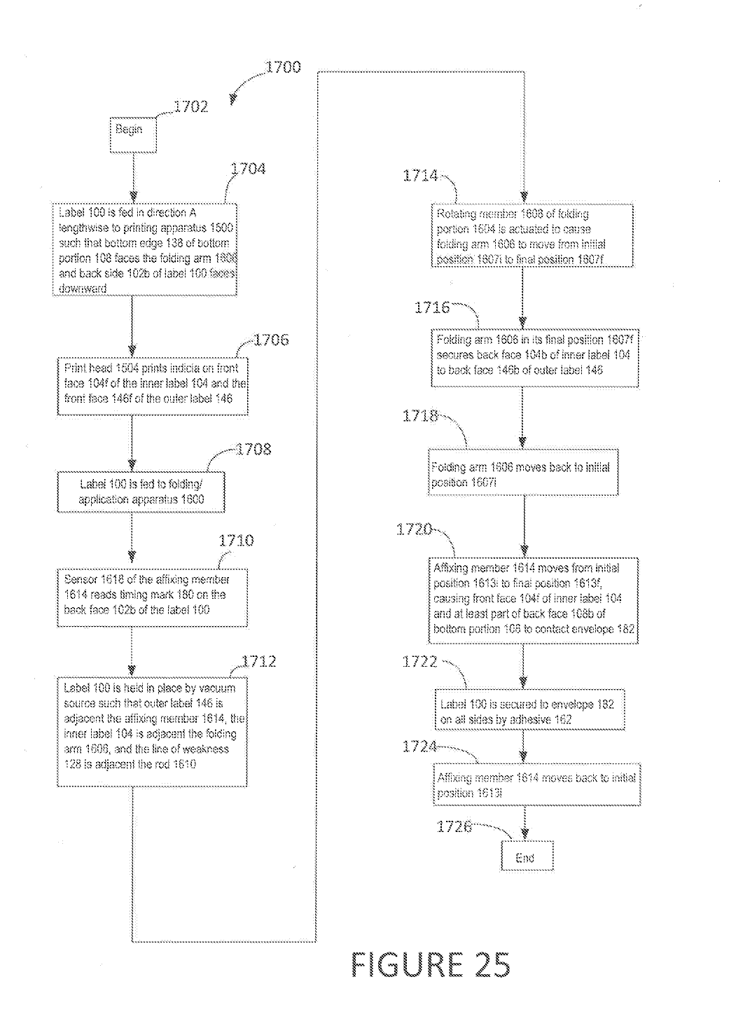

Attention is now directed to FIG. 25, which outlines a method 1700 of printing, folding, and applying the label 100 to the envelope 182. The method 1700 begins at step 1702, and at step 1704 the label 100 (see FIGS. 1 and 2) is fed in direction A (FIG. 18) lengthwise to the printing apparatus such the bottom edge 138 of the bottom portion 108 faces the folding arm 1606 and the back side 102b of the label 100 faces downward. At step 1706, the single print head 1504 may print indicia on the front face 104f of the inner label 104 and the front face 146f of the outer label 146. Once the printing is complete, the backing sheet 160 may be removed from the label 100 and the label 100 may be fed to the folding application/apparatus 1600 at step 1708. Specifically, the label 100 may be fed to the folding/apparatus 1600 such that the bottom edge 138 of the label 100 moves past the stop 1602 and the rotating member 1609, and becomes adjacent the affixing member 1614.

At step 1710, the sensor 1618 in the affixing member 1614 may read the timing mark 180 on the back face 102b of the label 100 and the label 100 may stop moving further in direction A. More particularly, at step 1712, the vacuum source may hold the label 100 in place such that the outer label 146 is adjacent the affixing member 1614, the inner label 104 is adjacent the folding arm 1606, and the line of weakness 128 is adjacent the rod 1610. The distances between the stop 1602, the folding portion 1604, and the application portion 1608 have been exaggerated in the figures for clarity. People of skill in the art will appreciate that the folding portion 1604 and the stop 1602 may be of a unitary construction.

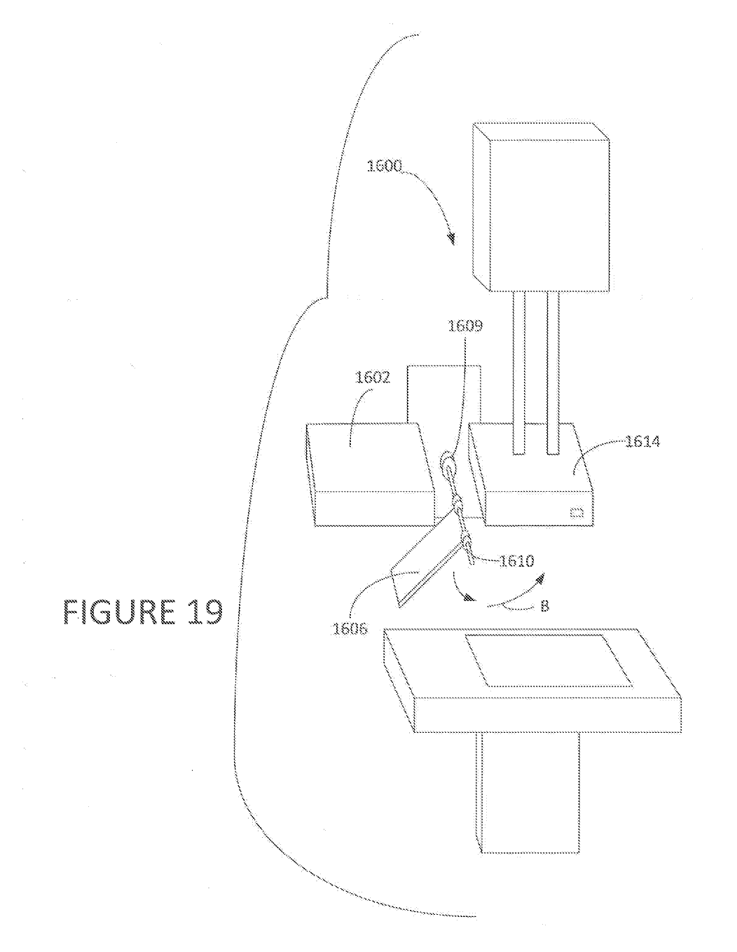

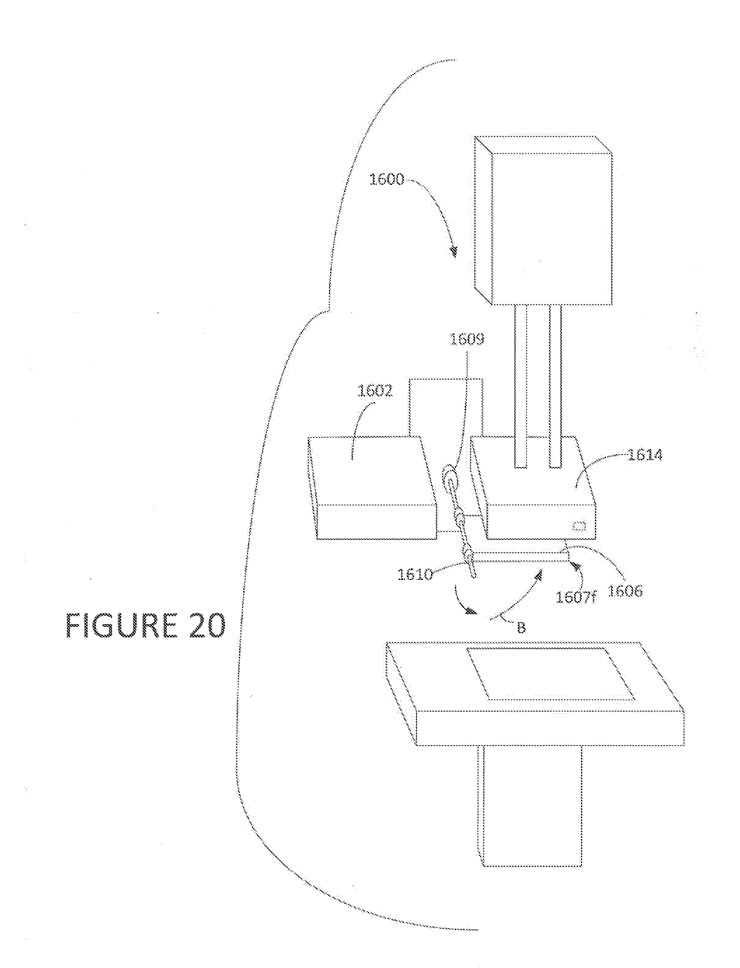

The rotating member 1609 of the folding portion 1604 may now be actuated at step 1714 to cause the folding arm 1606 to move from its initial (or first) position 1607i (FIG. 18) to its final (or second) position 1607f (FIG. 20). Specifically, as shown in FIGS. 18-20, the folding arm 1606 may move in direction B from its initial position 1607i adjacent the stop 1602 to its final position 1607f where it is adjacent the affixing member 1614. As the folding arm 1606 moves in direction B, it may cause the inner label 104 to travel along with it, and the back face 104b of the inner label 104 may in this way be brought into contact with and secured to the back face 146b of the outer label 146, as outlined in step 1716. People of skill in the art will appreciate that if no label 100 is being fed to the folding/application apparatus 1600 during operation, that at least part of the folding arm 1606 may contact the affixing member 1614.

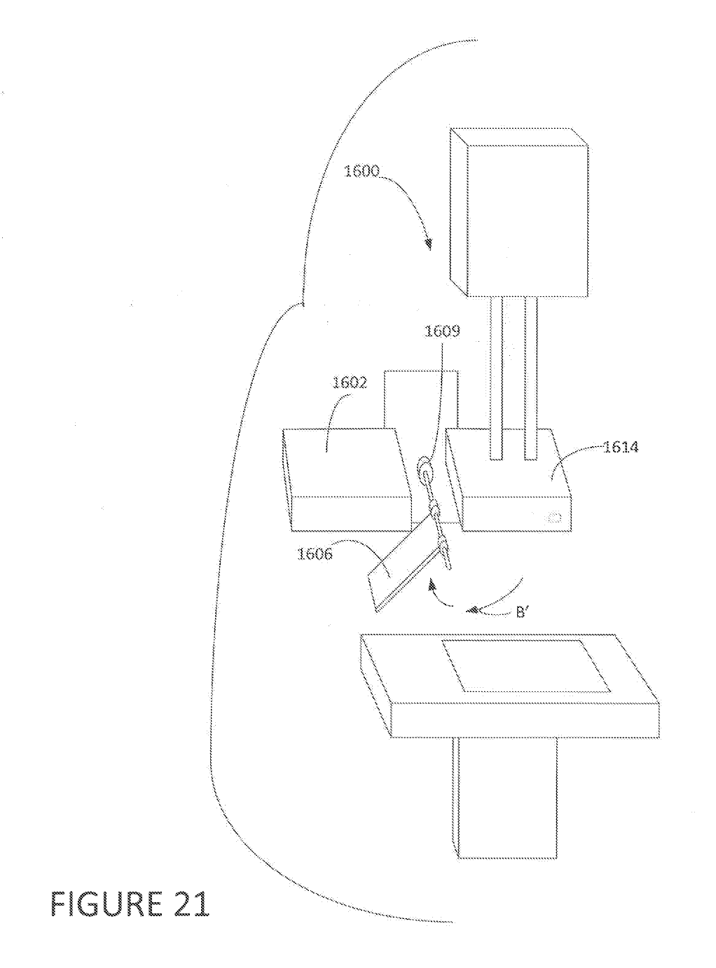

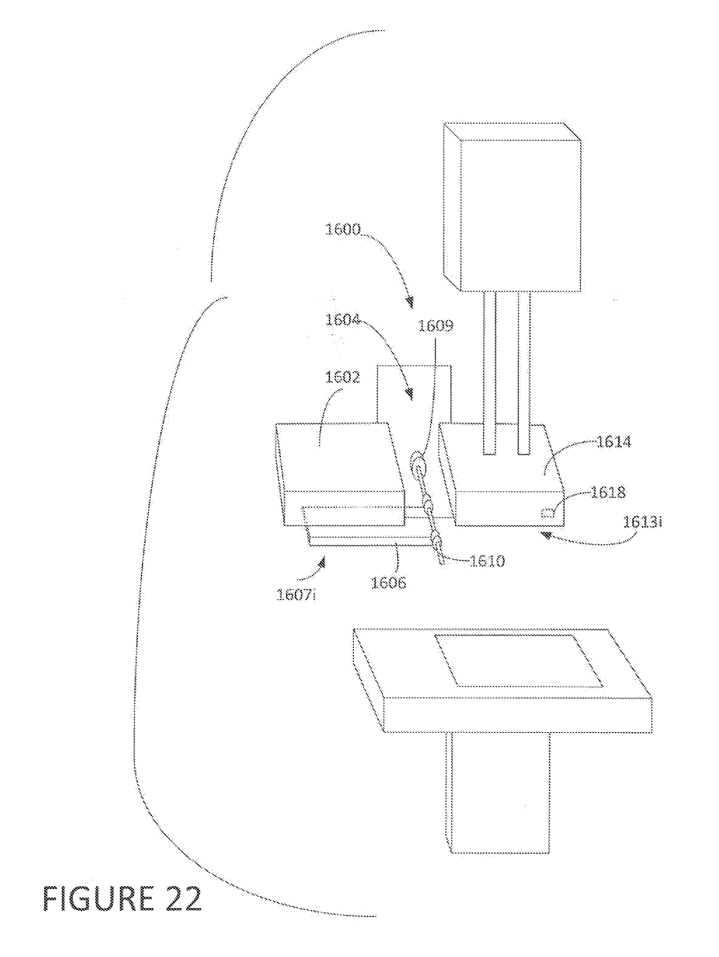

Next, at step 1718, the folding arm 1606 may travel in direction B′ back to its initial position 1607i as shown in FIGS. 21-23. Then, in step 1720, the extendable rods 1612 of the application portion 1608 may extend and cause the affixing member 1614 to move from its initial position 1613i to its final position 1613f (FIG. 23). This may cause the front face 104f of the inner label 104 and at least part of the back face 108b of the bottom portion 108 to become adjacent and contact the envelope 182. The folded label 100, thus, in step 1722, may be secured to the envelope 182 on all sides. The affixing member 1614 may then at step 1724 move back to its initial position 1613i, and the method 1700 may end at step 1726.

People of skill in the art when given the benefit of this disclosure will appreciate that method 1700 is merely an example of operation and that the printing, folding and application of the label 100 (or other label embodiments) to an envelope 182 may be effectuated in other ways. For example, the print and apply machine 1400 may be configured to allow the label 100 to be fed to it in any orientation (e.g., lengthwise, edgewise, face up, face down, bottom edge 138 first, top edge 114 first, et cetera). Or, for example, the folding arm 1606 may be physically coupled to the affixing member 1614 and/or be directly actuated (e.g., mechanically, hydraulically, electrically, pneumatically, et cetera), and need not necessarily be actuated via the rotating member 1609. Moreover, the label 100 may be manually applied to the envelope 182 after it is folded instead of being applied via the affixing member 1614 (i.e., the vacuum sources of affixing member 1614 may hold the label 100 in place after it is folded, and a user may disengage the label 100 from the affixing member 1614 and apply it to the envelope 182 by hand). Each of the stop 1602, the folding portion 1604, and the application portion 1608 may be of a unitary construction, and the folding/application apparatus 1600 may have its own printing apparatus 1500 or be provided as an attachment to existing label printing equipment. People of skill in the art will further appreciate that while the working of the print and apply machine 1400 has generally been described with reference to the label 100, that with little or no modification, the print and apply machine 1400 may be used to fold and apply other fold-under labels, including the various label embodiments disclosed herein. For example, when the print and apply machine 1400 is being used with the label 600, the card placing apparatus 696 (FIG. 17(b)) may be provided upstream of the folding/application apparatus 1600.

Indeed, many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. An apparatus for printing, folding, and applying a fold-under label to a substrate, the apparatus comprising:
a printing station including a printer;
a folding station having a stop, a rotatable member, and a folding arm operably coupled to the rotatable member; and
an application station having an affixing member operably coupled to an extendable rod;
wherein the folding arm is configured to fold the fold-under label by transitioning from a first position adjacent the stop to a second position adjacent the affixing member upon rotation of the rotatable member;
wherein the affixing member is configured to apply the folded fold-under label to the substrate by transitioning from an initial position to a final position.

2. The apparatus of claim 1, wherein the affixing member includes a sensor to read a timing mark on the fold-under label.

3. The apparatus of claim 2, wherein the affixing member includes a vacuum nozzle to hold the fold-under label adjacent the affixing member.

4. The apparatus of claim 3, wherein:
a second rod extends from the rotatable member; and
the folding arm is coupled to the second rod.

5. The apparatus of claim 4, wherein the rotatable member is actuated by at least one of a motor, a solenoid, a spring, a pressurized gas, and a pressurized fluid.

6. The apparatus of claim 4, wherein the folding station and the application station are of unitary construction.

7. The apparatus of claim 6, wherein the folding arm transitions back from the second position to the first position before the affixing member transitions from the initial position to the final position.

8. The apparatus of claim 6, wherein the printing station is upstream from the folding station and the application station.

9. An apparatus for folding and applying a fold-under label to a substrate, the apparatus comprising:
a folding station having a stop and a folding arm; and
an application station having an affixing member;
wherein the folding arm is configured to fold the fold-under label by transitioning from a first position adjacent the stop to a second position adjacent the affixing member;
wherein the affixing member is configured to apply the folded fold-under label to the substrate by transitioning from an initial position to a final position.

10. The apparatus of claim 9, further comprising a printing station including a printer.

11. The apparatus of claim 10 further comprising a rotatable member; and
wherein the folding arm is actuated by the rotatable member.

12. The apparatus of claim 11, wherein the affixing member includes a sensor to read a timing mark on the fold-under label.

13. The apparatus of claim 12, wherein the affixing member includes a vacuum nozzle to hold the fold-under label adjacent the affixing member.

14. The apparatus of claim 10, wherein the printing station is upstream of the folding station and the application station.

15. The apparatus of claim 13, wherein the affixing member is operably coupled to an extendable rod.

16. The apparatus of claim 15, further comprising a feeding mechanism configured to feed the fold-under-label to the printing station.

17. The apparatus of claim 16, further comprising a conveyer belt configured to transport the substrate after the fold-under label has been affixed thereto.

18. An apparatus for printing, folding, and applying a fold-under label to a substrate, the apparatus comprising:
a printing station including a printer;
a folding station having a stop and a folding arm; and
an application station having an affixing member; the affixing member comprising a sensor configured to read a timing mark on the fold-under label;
wherein the folding arm is configured to fold the fold-under label by transitioning from a first position adjacent the stop to a second position adjacent the affixing member;
wherein the affixing member is configured to apply the folded fold-under label to the substrate by transitioning from an initial position to a final position.

19. The apparatus of claim 18, wherein the folding of the fold-under label by the folding arm is effectuated when the fold-under label is adjacent the folding arm and the affixing member.

20. The apparatus of claim 19 wherein:
the printing station is upstream of the folding station;
the affixing member includes a vacuum nozzle to hold the fold-under label against the affixing member; and
the affixing member is operably coupled to an extendable rod.

21. An apparatus for printing and folding a fold-under label, the apparatus comprising:
a printing station including a printer; and
a folding station having a stop and a folding arm operably coupled to a rotatable member;
wherein the folding arm is configured to fold the fold-under label by transitioning from a first position to a second position upon rotation of the rotatable member.
